(19) United States
(12) Patent Application Publication
(10) Pub. No.: US 2025/0035897 A1
(43) Pub. Date: Jan. 30, 2025

(54) ZOOM LENS

(71) Applicant: Genius Electronic Optical (Xiamen) Co., Ltd., Xiamen (CN)

(72) Inventors: Huabin Liao, Xiamen (CN); Wei-Jeh Kao, Taichung City (TW); Ying-Hua Lin, Taichung City (TW); Hung-Chien Hsieh, Taichung City (TW)

(73) Assignee: Genius Electronic Optical (Xiamen) Co., Ltd., Xiamen (CN)

(21) Appl. No.: 18/592,538

(22) Filed: Mar. 1, 2024

(30) Foreign Application Priority Data
Jul. 26, 2023 (CN) 202310928180.9

(51) Int. Cl. G02B 15/14

(52) U.S. Cl. CPC G02B 15/143

(57) ABSTRACT

A zoom lens sequentially includes a first lens group, a second lens group and a third lens group along an optical axis from an object side to an image side. The zoom lens at least has a wide-angle state and a telephoto state, the second lens group has positive refracting power, and the zoom lens has only the above three lens groups and satisfies the following relationships: TTL*(Fnow+Fnot)/fw≤20.000, (ft+fw)/ImgH≥9.000 and ft/fw≥1.600. TTL is a system length of the zoom lens, Fnow is an f-number of the zoom lens in the wide-angle state, Fnot is an f-number of the zoom lens in the telephoto state, fw is an effective focal length of the zoom lens in the wide-angle state, ft is an effective focal length of the zoom lens in the telephoto state, and ImgH is a maximum image height of the zoom lens.

### BACKGROUND OF THE INVENTION

### 1. Field of the Invention

The present invention relates generally to a zoom lens. Specifically, the present invention is directed to a zoom lens mainly used for shooting images and videos, and can be applied to portable electronic products such as mobile phones, cameras, tablet computers, head-mounted displays (AR, VR, MR), etc.

### 2. Description of the Prior Art

The specifications of portable electronic products are changing with each passing day, and its key component: zoom lens is also developing more diversified. The application is not limited to shooting images and videos, but also meets the needs of telephoto camera shooting. The existing portable electronic products mainly adopt f35 (35 mm equivalent focal length)=26 mm wide-angle lens, and cooperate with f35=52 mm telephoto lens to achieve the function of 2-fold zoom. Because digital zoom zooms by switching lens elements with different fixed focal lengths, the image resolution will be discontinuous at the time when the camera system switches lens elements, which requires additional computing power of portable electronic products for image processing. Even if the image is processed, the image resolution will still be affected when switching lens elements with different focal lengths. In addition, due to the use of digital zoom, when the focal length of the telephoto lens is more than 2 times that of the wide-angle lens, the focal length difference between the two lens elements will increase the difficulty of image processing.

However, the existing zoom lens is much larger than the thickness of portable electronic products, so it cannot be installed on portable electronic products. Therefore, how to provide a telephoto lens which can be installed in portable electronic products and has a higher zoom ratio than f35=26 mm, and at the same time, the image will not be too distorted when the lens is switched is a problem that needs to be solved in the industry.

### SUMMARY OF THE INVENTION

Embodiments of the present invention propose that a first lens group, a second lens group and a third lens group are sequentially included along an optical axis from an object side to an image side, wherein the zoom lens has at least a wide-angle state and a telephoto state.

In an embodiment of the present invention, the second lens group has positive refracting power, and there are only three lens groups of the zoom lens and the following relationships are satisfied: TTL*(Fnow+Fnot)/fw≤20.000, (ft+fw)/ImgH≥9.000 and ft/fw≥1.600, wherein TTL is the distance from the object-side surface of the first lens element to an image plane along the optical axis, Fnow is the f-number of the zoom lens in the wide-angle state, Fnot is the f-number of the zoom lens in the telephoto state, fw is the effective focal length of the zoom lens in the wide-angle state, ft is the effective focal length of the zoom lens in the telephoto state, and ImgH is the maximum image height of the zoom lens.

In an embodiment of the present invention, the third lens group has negative refracting power, and there are only three lens groups of the zoom lens and the following relationships are satisfied: TTL*(Fnow+Fnot)/fw≤20.000, (ft+fw)/ImgH≥9.000 and ft/fw≥1.600, wherein TTL is the distance from the object-side surface of the first lens element to an image plane along the optical axis, Fnow is the f-number of the zoom lens in the wide-angle state, Fnot is the f-number of the zoom lens in the telephoto state, fw is the effective focal length of the zoom lens in the wide-angle state, ft is the effective focal length of the zoom lens in the telephoto state, and ImgH is the maximum image height of the zoom lens.

In an embodiment of the present invention, the third lens group has a lens element closest to the image side, a periphery region of the image-side surface of the lens element closest to the image side is convex, and there are only three lens groups of the zoom lens, and the following relationships are satisfied: TTL*(Fnow+Fnot)/fw≤20.000 and (ft+fw)/ImgH≥9.000, wherein TTL is the distance from the object-side surface of the first lens element to an image plane along the optical axis, Fnow is the f-number of the zoom lens in the wide-angle state, Fnot is the f-number of the zoom lens in the telephoto state, fw is the effective focal length of the zoom lens in the wide-angle state, ft is the effective focal length of the zoom lens in the telephoto state, and ImgH is the maximum image height of the zoom lens.

In addition, the first lens group, the second lens group and the third lens group of the zoom lens of the present invention at least sequentially include a first lens element, a second lens element, a third lens element, a fourth lens element, a fifth lens element, a sixth lens element, a seventh lens element and an eighth lens element (in some embodiments of the present invention, a ninth lens element is further included between the eighth lens element and the image side), and each lens element has an object-side surface facing toward the object side and allowing imaging rays to pass through as well as an image-side surface facing toward the image side and allowing the imaging rays to pass through.

In the zoom lens of the present invention, each embodiment may also selectively satisfy the following relationships:
the lens element closest to the image side has negative refracting power;

$$DG 3 / ( DG 1 + DG 2 ) \leq 1.5 ; ( ft + fw + EPDt + EPDw ) / ( Gall + DG 3 ) \geq 1.79 ; ( ft / fw ) / DG 3 \geq 3.8 ;$$

the first lens element of the zoom lens has positive refracting power;

$$\begin{matrix}( ER 11 + ER 12 + ER 21 + ER 22 + ER 31 + ER 32 ) / EPDt \leq 3.7 ; \\ ( ER 61 + ER 62 + ER 71 + ER 72 + ER 81 + ER 82 ) / EPDw \leq 4.2 ; \\ ( ER 17 + ER 72 + ER 81 + ER 82 ) / ( T 5 + T 6 + T 7 ) \leq 3.8 ; \\ ( ER 17 + ER 72 + ER 81 + ER 82 ) / ( T 1 + T 4 + T 8 ) \leq 3.8 ; \\ ( Gall + T 2 + T 3 ) / ALT \leq 2.8 ; \\ DG 3 / ( T 4 + T 7 ) \leq 3. ; \\ DG 3 / ( T 1 + T 5 ) \leq 5.2 ; \\ DG 3 / ( T 4 + T 6 ) \leq 4.1 ; \\ DG 3 / ( T 6 + T 7 ) \leq 6. ; \\ DG 3 / ( T 7 + T 8 ) \leq 4.6 ; \\ DG 3 / D 71 t 82 \leq 3.6 ; and \\ ( T 2 + T 3 + G 67 ) / ( T 5 + G 78 ) \leq 3.2 .\end{matrix}$$

In the present invention, EPDt is the entrance pupil diameter of the zoom lens in the telephoto state, EPDw is the entrance pupil diameter of the zoom lens in the wide-angle state, Gall is the sum of air gaps along the optical axis of all lens elements of the zoom lens plus back focal length, DG1 is the length of the first lens group along the optical axis, DG2 is the length of the second lens group along the optical axis, DG3 is the length of the third lens group along the optical axis, T1 is the thickness of the first lens element along the optical axis, T2 is the thickness of the second lens element along the optical axis, T3 is the thickness of the third lens element along the optical axis, T4 is the thickness of the fourth lens element along the optical axis, T5 is the thickness of the fifth lens element along the optical axis, T6 is the thickness of the sixth lens element along the optical axis, T7 is the thickness of the seventh lens element along the optical axis, T8 is the thickness of the eighth lens element along the optical axis, ER11 is the effective radius of the object-side surface of the first lens element. ER12 is the effective radius of the image-side surface of the first lens element, ER21 is the effective radius of the object-side surface of the second lens element, ER22 is the effective radius of the image-side surface of the second lens element, ER31 is the effective radius of the object-side surface of the third lens element, ER32 is the effective radius of the image-side surface of the third lens element, ER61 is the effective radius of the object-side surface of the sixth lens element, ER62 is the effective radius of the image-side surface of the sixth lens element. ER71 is the effective radius of the object-side surface of the seventh lens element, ER72 is the effective radius of the image-side surface of the seventh lens element, ER81 is the effective radius of the object-side surface of the eighth lens element, ER82 is the effective radius of the image-side surface of the eighth lens element, D71t82 is the distance from the object-side surface of the seventh lens element to the image-side surface of the eighth lens element along the optical axis, G67 is the air gap between the sixth lens element and the seventh lens element along the optical axis, and G78 is the air gap between the seventh lens element and the eighth lens element along the optical axis.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-5 illustrate the methods for determining the surface shapes and for determining optical axis region or periphery region of one lens element.

FIG. 6A is a schematic diagram showing the wide-angle state of the first embodiment of the zoom lens of the present invention.

FIG. 6B is a schematic diagram showing the telephoto state of the first embodiment of the zoom lens of the present invention.

FIG. 7A shows the longitudinal spherical aberration in the wide-angle state of the first embodiment on the image plane.

FIG. 7B shows the field curvature aberration on the sagittal direction in the wide-angle state of the first embodiment.

FIG. 7C shows the field curvature aberration on the tangential direction in the wide-angle state of the first embodiment.

FIG. 7D shows the distortion aberration in the wide-angle state of the first embodiment.

FIG. 7E shows the longitudinal spherical aberration in the telephoto state of the first embodiment on the image plane.

FIG. 7F shows the field curvature aberration on the sagittal direction in the telephoto state of the first embodiment.

FIG. 7G shows the field curvature aberration on the tangential direction in the telephoto state of the first embodiment.

FIG. 7H shows the distortion aberration in the telephoto state of the first embodiment.

FIG. 8 is a schematic diagram showing the wide-angle state of the second embodiment of the zoom lens of the present invention.

FIG. 9A shows the longitudinal spherical aberration in the wide-angle state of the second embodiment on the image plane.

FIG. 9B shows the field curvature aberration on the sagittal direction in the wide-angle state of the second embodiment.

FIG. 9C shows the field curvature aberration on the tangential direction in the wide-angle state of the second embodiment.

FIG. 9D shows the distortion aberration in the wide-angle state of the second embodiment.

FIG. 9E shows the longitudinal spherical aberration in the telephoto state of the second embodiment on the image plane.

FIG. 9F shows the field curvature aberration on the sagittal direction in the telephoto state of the second embodiment.

FIG. 9G shows the field curvature aberration on the tangential direction in the telephoto state of the second embodiment.

FIG. 9H shows the distortion aberration in the telephoto state of the second embodiment.

FIG. 10 is a schematic diagram showing the wide-angle state of the third embodiment of the zoom lens of the present invention.

FIG. 11A shows the longitudinal spherical aberration in the wide-angle state of the third embodiment on the image plane.

FIG. 11B shows the field curvature aberration on the sagittal direction in the wide-angle state of the third embodiment.

FIG. 11C shows the field curvature aberration on the tangential direction in the wide-angle state of the third embodiment.

FIG. 11D shows the distortion aberration in the wide-angle state of the third embodiment.

FIG. 11E shows the longitudinal spherical aberration in the telephoto state of the third embodiment on the image plane.

FIG. 11F shows the field curvature aberration on the sagittal direction in the telephoto state of the third embodiment.

FIG. 11G shows the field curvature aberration on the tangential direction in the telephoto state of the third embodiment.

FIG. 11H shows the distortion aberration in the telephoto state of the third embodiment.

FIG. 12 is a schematic diagram showing the wide-angle state of the fourth embodiment of the zoom lens of the present invention.

FIG. 13A shows the longitudinal spherical aberration in the wide-angle state of the fourth embodiment on the image plane.

FIG. 13B shows the field curvature aberration in the wide-angle state on the sagittal direction of the fourth embodiment.

FIG. 13C shows the field curvature aberration on the tangential direction in the wide-angle state of the fourth embodiment.

FIG. 13D shows the distortion aberration in the wide-angle state of the fourth embodiment.

FIG. 13E shows the longitudinal spherical aberration in the telephoto state of the fourth embodiment on the image plane.

FIG. 13F shows the field curvature aberration of the fourth embodiment on the sagittal direction.

FIG. 13G shows the field curvature aberration on the tangential direction in the telephoto state of the fourth embodiment.

FIG. 13H shows the distortion aberration in the telephoto state of the fourth embodiment.

FIG. 14 is a schematic diagram showing the wide-angle state of the fifth embodiment of the zoom lens of the present invention.

FIG. 15A shows the longitudinal spherical aberration in the wide-angle state of the fifth embodiment on the image plane.

FIG. 15B shows the field curvature aberration on the sagittal direction in the wide-angle state of the fifth embodiment.

FIG. 15C shows the field curvature aberration on the tangential direction in the wide-angle state of the fifth embodiment.

FIG. 15D shows the distortion aberration in the wide-angle state of the fifth embodiment.

FIG. 15E shows the longitudinal spherical aberration in the telephoto state of the fifth embodiment on the image plane.

FIG. 15F shows the field curvature aberration of the fifth embodiment on the sagittal direction.

FIG. 15G shows the field curvature aberration on the tangential direction in the telephoto state of the fifth embodiment.

FIG. 15H shows the distortion aberration in the telephoto state of the fifth embodiment.

FIG. 16 is a schematic diagram showing the wide-angle state of the sixth embodiment of the zoom lens of the present invention.

FIG. 17A shows the longitudinal spherical aberration in the wide-angle state of the sixth embodiment on the image plane.

FIG. 17B shows the field curvature aberration on the sagittal direction in the wide-angle state of the sixth embodiment.

FIG. 17C shows the field curvature aberration on the tangential direction in the wide-angle state of the sixth embodiment.

FIG. 17D shows the distortion aberration in the wide-angle state of the sixth embodiment.

FIG. 17E shows the longitudinal spherical aberration in the telephoto state of the sixth embodiment on the image plane.

FIG. 17F shows the field curvature aberration on the sagittal direction in the telephoto state of the sixth embodiment.

FIG. 17G shows the field curvature aberration on the tangential direction in the telephoto state of the sixth embodiment.

FIG. 17H shows the distortion aberration in the telephoto state of the sixth embodiment.

FIG. 18 is a schematic diagram showing the wide-angle state of the seventh embodiment of the zoom lens of the present invention.

FIG. 19A shows the longitudinal spherical aberration in the wide-angle state of the seventh embodiment on the image plane.

FIG. 19B shows the field curvature aberration on the sagittal direction in the wide-angle state of the seventh embodiment.

FIG. 19C shows the field curvature aberration on the tangential direction in the wide-angle state of the seventh embodiment.

FIG. 19D shows the distortion aberration in the wide-angle state of the seventh embodiment.

FIG. 19E shows the longitudinal spherical aberration in the telephoto state of the seventh embodiment on the image plane.

FIG. 19F shows the field curvature aberration on the sagittal direction in the telephoto state of the seventh embodiment.

FIG. 19G shows the field curvature aberration on the tangential direction in the telephoto state of the seventh embodiment.

FIG. 19H shows the distortion aberration of the telephoto state of the seventh embodiment.

FIG. 20 is a schematic diagram showing the wide-angle state of the eighth embodiment of the zoom lens of the present invention.

FIG. 21A shows the longitudinal spherical aberration in the wide-angle state of the eighth embodiment on the image plane.

FIG. 21B shows the field curvature aberration on the sagittal direction in the wide-angle state of the eighth embodiment.

FIG. 21C shows the field curvature aberration on the tangential direction in the wide-angle state of the eighth embodiment.

FIG. 21D shows the distortion aberration in the wide-angle state of the eighth embodiment.

FIG. 21E shows the longitudinal spherical aberration in the telephoto state of the eighth embodiment on the image plane.

FIG. 21F shows the field curvature aberration on the sagittal direction in the telephoto state of the eighth embodiment.

FIG. 21G shows the field curvature aberration on the tangential direction in the telephoto state of the eighth embodiment.

FIG. 21H shows the distortion aberration in the telephoto state of the eighth embodiment.

FIG. 22 is a schematic diagram showing the wide-angle state of the ninth embodiment of the zoom lens of the present invention.

FIG. 23A shows the longitudinal spherical aberration in the wide-angle state of the ninth embodiment on the image plane.

FIG. 23B shows the field curvature aberration of the ninth embodiment on the sagittal direction.

FIG. 23C shows the field curvature aberration on the tangential direction in the wide-angle state of the ninth embodiment.

FIG. 23D shows the distortion aberration in the wide-angle state of the ninth embodiment.

FIG. 23E shows the longitudinal spherical aberration in the telephoto state of the ninth embodiment on the image plane.

FIG. 23F shows the field curvature aberration on the sagittal direction in the telephoto state of the ninth embodiment.

FIG. 23G shows the field curvature aberration on the tangential direction in the telephoto state of the ninth embodiment.

FIG. 23H shows the distortion aberration in the telephoto state of the ninth embodiment.

FIG. 24 shows the optical data of the first embodiment.

FIG. 25 shows the aspheric surface data of the first embodiment.

FIG. 26 shows the optical data of the second embodiment.

FIG. 27 shows the aspheric surface data of the second embodiment.

FIG. 28 shows the optical data of the third embodiment.

FIG. 29 shows the aspheric surface data of the third embodiment.

FIG. 30 shows the optical data of the fourth embodiment.

FIG. 31 shows the aspheric surface data of the fourth embodiment.

FIG. 32 shows the optical data of the fifth embodiment.

FIG. 33 shows the aspheric surface data of the fifth embodiment.

FIG. 34 shows the optical data of the sixth embodiment.

FIG. 35 shows the aspheric surface data of the sixth embodiment.

FIG. 36 shows the optical data of the seventh embodiment.

FIG. 37 shows the aspheric surface data of the seventh embodiment.

FIG. 38 shows the optical data of the eighth embodiment.

FIG. 39 shows the aspheric surface data of the eighth embodiment.

FIG. 40 shows the optical data of the ninth embodiment.

FIG. 41 shows the aspheric surface data of the ninth embodiment.

FIG. 42 shows important ratios of each embodiment.

FIG. 43 shows important ratios of each embodiment.

### DETAILED DESCRIPTION

The terms “optical axis region”, “periphery region”, “concave”, and “convex” used in this specification and claims should be interpreted based on the definition listed in the specification by the principle of lexicographer.

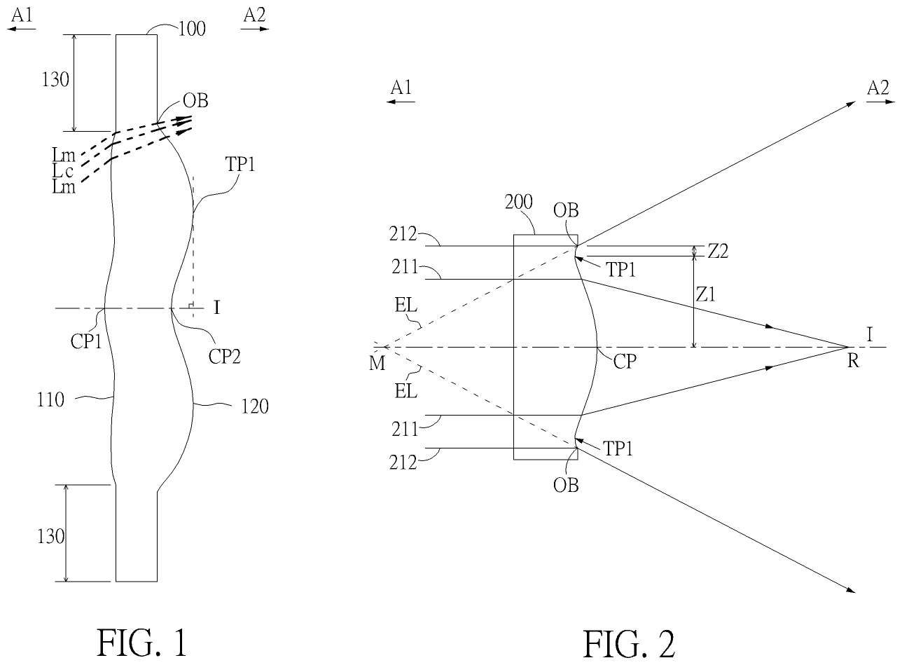

In the present disclosure, the optical system may comprise at least one lens element to receive imaging rays that are incident on the optical system over a set of angles ranging from parallel to an optical axis to a half field of view (HFOV) angle with respect to the optical axis. The imaging rays pass through the optical system to produce an image on an image plane. The term “a lens element having positive refracting power (or negative refracting power)” means that the paraxial refracting power of the lens element in Gaussian optics is positive (or negative). The term “an object-side (or image-side) surface of a lens element” refers to a specific region of that surface of the lens element at which imaging rays can pass through that specific region. Imaging rays include at least two types of rays: a chief ray Lc and a marginal ray Lm (as shown in FIG. 1). An object-side (or image-side) surface of a lens element can be characterized as having several regions, including an optical axis region, a periphery region, and, in some cases, one or more intermediate regions, as discussed more fully below.

FIG. 1 is a radial cross-sectional view of a lens element 100. Two referential points for the surfaces of the lens element 100 can be defined: a central point, and a transition point. The central point of a surface of a lens element is a point of intersection of that surface and the optical axis I. As illustrated in FIG. 1, a first central point CP1 may be present on the object-side surface 110 of lens element 100 and a second central point CP2 may be present on the image-side surface 120 of the lens element 100. The transition point is a point on a surface of a lens element, at which the line tangent to that point is perpendicular to the optical axis I. The optical boundary OB of a surface of the lens element is defined as a point at which the radially outermost marginal ray Lm passing through the surface of the lens element intersects the surface of the lens element. All transition points lie between the optical axis I and the optical boundary OB of the surface of the lens element. A surface of the lens element 100 may have no transition point or have at least one transition point. If multiple transition points are present on a single surface, then these transition points are sequentially named along the radial direction of the surface with reference numerals starting from the first transition point. For example, the first transition point, e.g., TP1, (closest to the optical axis I), the second transition point, e.g., TP2, (as shown in FIG. 4), and the Nth transition point (farthest from the optical axis I).

When a surface of the lens element has at least one transition point, the region of the surface of the lens element from the central point to the first transition point TP1 is defined as the optical axis region, which includes the central point. The region located radially outside of the farthest transition point (the Nth transition point) from the optical axis I to the optical boundary OB of the surface of the lens element is defined as the periphery region. In some embodiments, there may be intermediate regions present between the optical axis region and the periphery region, with the number of intermediate regions depending on the number of the transition points. When a surface of the lens element has no transition point, the optical axis region is defined as a region of 0%-50% of the distance between the optical axis I and the optical boundary OB of the surface of the lens element, and the periphery region is defined as a region of 50%-100% of the distance between the optical axis I and the optical boundary OB of the surface of the lens element.

The shape of a region is convex if a collimated ray being parallel to the optical axis I and passing through the region is bent toward the optical axis I such that the ray intersects the optical axis I on the image side A2 of the lens element. The shape of a region is concave if the extension line of a collimated ray being parallel to the optical axis I and passing through the region intersects the optical axis I on the object side A1 of the lens element.

Additionally, referring to FIG. 1, the lens element 100 may also have a mounting portion 130 extending radially outward from the optical boundary OB. The mounting portion 130 is typically used to physically secure the lens element to a corresponding element of the optical system (not shown). Imaging rays do not reach the mounting portion 130. The structure and shape of the mounting portion 130 are only examples to explain the technologies, and should not be taken as limiting the scope of the present disclosure. The mounting portion 130 of the lens elements discussed below may be partially or completely omitted in the following drawings.

Referring to FIG. 2, optical axis region Z1 is defined between central point CP and first transition point TP1. Periphery region Z2 is defined between TP1 and the optical boundary OB of the surface of the lens element. Collimated ray 211 intersects the optical axis I on the image side A2 of lens element 200 after passing through optical axis region Z1, i.e., the focal point of collimated ray 211 after passing through optical axis region Z1 is on the image side A2 of the lens element 200 at point R in FIG. 2. Accordingly, since the ray itself intersects the optical axis I on the image side A2 of the lens element 200, optical axis region Z1 is convex. On the contrary, collimated ray 212 diverges after passing through periphery region Z2. The extension line EL of collimated ray 212 after passing through periphery region Z2 intersects the optical axis I on the object side A1 of lens element 200, i.e., the focal point of collimated ray 212 after passing through periphery region Z2 is on the object side A1 at point M in FIG. 2. Accordingly, since the extension line EL of the ray intersects the optical axis I on the object side A1 of the lens element 200, periphery region Z2 is concave. In the lens element 200 illustrated in FIG. 2, the first transition point TP1 is the border of the optical axis region and the periphery region, i.e., TP1 is the point at which the shape changes from convex to concave.

Alternatively, there is another way for a person having ordinary skill in the art to determine whether an optical axis region is convex or concave by referring to the sign of “Radius of curvature” (the “R” value), which is the paraxial radius of shape of a lens surface in the optical axis region. The R value is commonly used in conventional optical design software such as Zemax and CodeV. The R value usually appears in the lens data sheet in the software. For an object-side surface, a positive R value defines that the optical axis region of the object-side surface is convex, and a negative R value defines that the optical axis region of the object-side surface is concave. Conversely, for an image-side surface, a positive R value defines that the optical axis region of the image-side surface is concave, and a negative R value defines that the optical axis region of the image-side surface is convex. The result found by using this method should be consistent with the method utilizing intersection of the optical axis by rays/extension lines mentioned above, which determines surface shape by referring to whether the focal point of a collimated ray being parallel to the optical axis I is on the object-side or the image-side of a lens element. As used herein, the terms “a shape of a region is convex (concave),” “a region is convex (concave),” and “a convex-(concave-) region,” can be used alternatively.

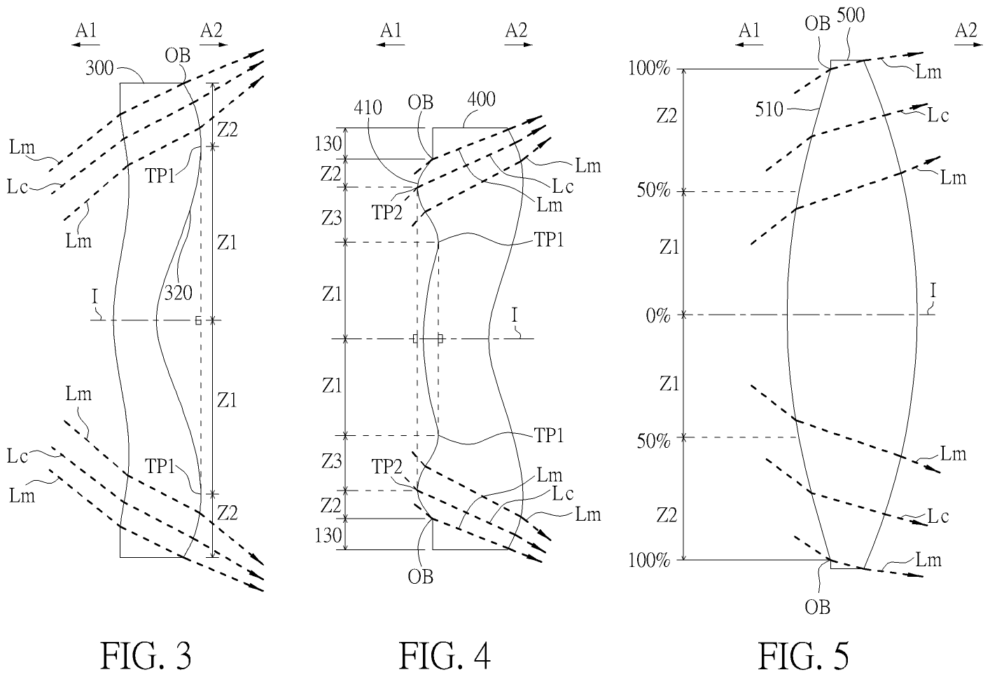

FIG. 3, FIG. 4 and FIG. 5 illustrate examples of determining the shape of lens element regions and the boundaries of regions under various circumstances, including the optical axis region, the periphery region, and intermediate regions as set forth in the present specification.

FIG. 3 is a radial cross-sectional view of a lens element 300. As illustrated in FIG. 3, only one transition point TP1 appears within the optical boundary OB of the image-side surface 320 of the lens element 300. Optical axis region Z1 and periphery region Z2 of the image-side surface 320 of lens element 300 are illustrated. The R value of the image-side surface 320 is positive (i.e., R>0). Accordingly, the optical axis region Z1 is concave.

In general, the shape of each region demarcated by the transition point will have an opposite shape to the shape of the adjacent region(s). Accordingly, the transition point will define a transition in shape, changing from concave to convex at the transition point or changing from convex to concave. In FIG. 3, since the shape of the optical axis region Z1 is concave, the shape of the periphery region Z2 will be convex as the shape changes at the transition point TP1.

FIG. 4 is a radial cross-sectional view of a lens element 400. Referring to FIG. 4, a first transition point TP1 and a second transition point TP2 are present on the object-side surface 410 of lens element 400. The optical axis region Z1 of the object-side surface 410 is defined between the optical axis I and the first transition point TP1. The R value of the object-side surface 410 is positive (i.e., R>0). Accordingly, the optical axis region Z1 is convex.

The periphery region Z2 of the object-side surface 410, which is also convex, is defined between the second transition point TP2 and the optical boundary OB of the object-side surface 410 of the lens element 400. Further, intermediate region Z3 of the object-side surface 410, which is concave, is defined between the first transition point TP1 and the second transition point TP2. Referring once again to FIG. 4, the object-side surface 410 includes an optical axis region Z1 located between the optical axis I and the first transition point TP1, an intermediate region Z3 located between the first transition point TP1 and the second transition point TP2, and a periphery region Z2 located between the second transition point TP2 and the optical boundary OB of the object-side surface 410. Since the shape of the optical axis region Z1 is designed to be convex, the shape of the intermediate region Z3 is concave as the shape of the intermediate region Z3 changes at the first transition point TP1, and the shape of the periphery region Z2 is convex as the shape of the periphery region Z2 changes at the second transition point TP2.

FIG. 5 is a radial cross-sectional view of a lens element 500. Lens element 500 has no transition point on the object-side surface 510 of the lens element 500. For a surface of a lens element with no transition point, for example, the object-side surface 510 the lens element 500, the optical axis region Z1 is defined as the region of 0%-50% of the distance between the optical axis I and the optical boundary OB of the surface of the lens element and the periphery region is defined as the region of 50%-100% of the distance between the optical axis I and the optical boundary OB of the surface of the lens element. Referring to lens element 500 illustrated in FIG. 5, the optical axis region Z1 of the object-side surface 510 is defined between the optical axis I and 50% of the distance between the optical axis I and the optical boundary OB. The R value of the object-side surface 510 is positive (i.e., R>0). Accordingly, the optical axis region Z1 is convex. For the object-side surface 510 of the lens element 500, because there is no transition point, the periphery region Z2 of the object-side surface 510 is also convex. It should be noted that lens element 500 may have a mounting portion (not shown) extending radially outward from the periphery region Z2.

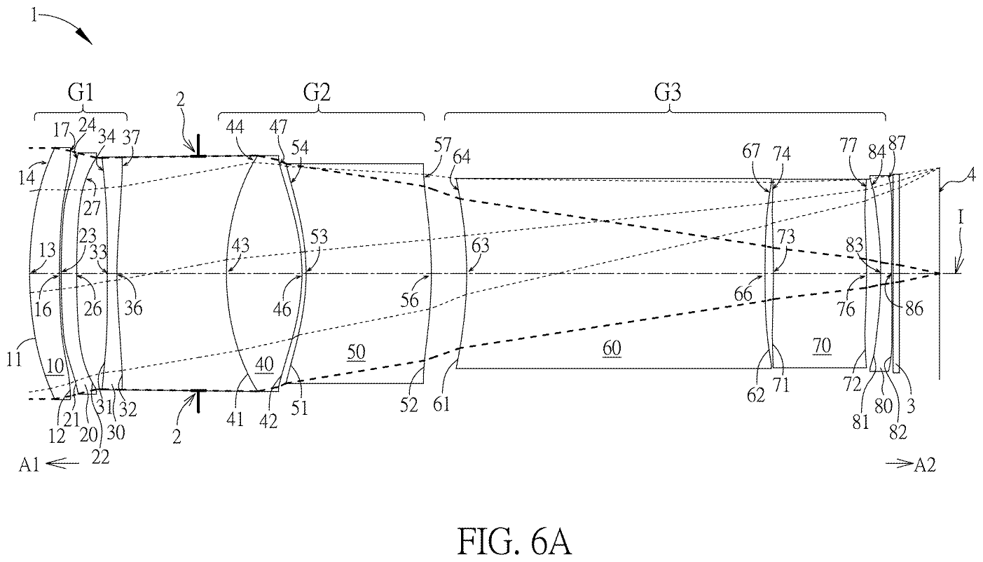

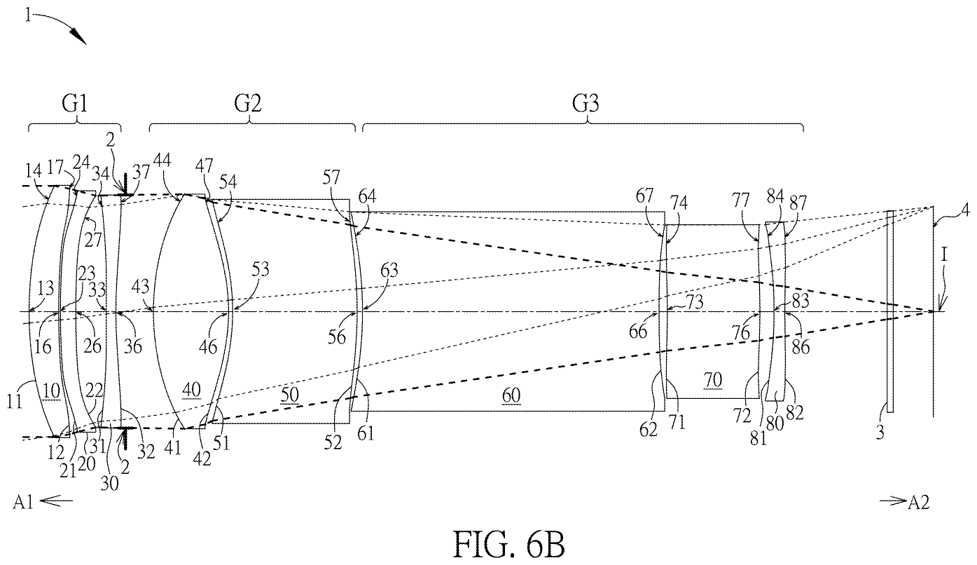

As shown in FIG. 6A or FIG. 6B, this embodiment provides a zoom lens 1, which is mainly composed of eight lens elements along the optical axis I from an object side A1 on which an object (not shown) is placed to an image side A2, and sequentially includes a first lens group G1, an aperture stop (ape. stop) 2, a second lens group G2, a third lens group G3 and an image plane 4. The first lens group G1, the second lens group G2 and the third lens group G3 each contain several lens elements. In the present invention, along the optical axis I from the object side A1 to the image side A2, the lens elements comprises a first lens element 10, a second lens element 20, a third lens element 30, a fourth lens element 40, a fifth lens element 50, a sixth lens element 60, a seventh lens element 70 and an eighth lens element 80 in sequence. (In some embodiments, a ninth lens element 90 is further included and located between the eighth lens element 80 and the image side A2, but the ninth lens element 90 is not included in this embodiment). In this embodiment, the first lens group G1 includes three lens elements, the second lens group G2 includes two lens elements, and the third lens group G3 includes three lens elements. Therefore, a lens element in a first order from the object side A1 in the first lens group G1 is the first lens element 10, a lens element in a second order from the object side A1 in the first lens group G1 is the second lens element 20, and a lens element in a third order from the object side A1 in the first lens group G1 is the third lens element 30. A lens element in a first order from the object side A1 in the second lens group G2 is the fourth lens element 40, a lens element in a second order from the object side A1 in the second lens group G2 is the fifth lens element 50. A lens element in a first order from the object side A1 in the third lens group G3 is the sixth lens element 60, a lens element in a second order from the object side A1 in the third lens group G3 is the seventh lens element 70, and a lens element in a third order from the object side A1 in the third lens group G3 is the eighth lens element 80, but the present invention is not limited to this. In other embodiments of the present invention, the number of lens elements included in the first lens group G1, the second lens group G2 and the third lens group G3 may be different.

The second lens group G2 and the third lens group G3 can move along the optical axis I, so that the zoom lens 1 can form several different focusing states, for example, a wide-angle state or a telephoto state, which respectively correspond to the states of FIG. 6A and FIG. 6B. The wide-angle state can be a short-focus state, in which the air gap between the first lens group G1, the second lens group G2 and the third lens group G3 is relatively large, while the telephoto state can be a long-focus state, in which the air gap between the first lens group G1, the second lens group G2 and the third lens group G3 is relatively small.

Generally speaking, the first lens element 10, the second lens element 20, the third lens element 30, the fourth lens element 40, the fifth lens element 50, the sixth lens element 60, the seventh lens element 70, the eighth lens element 80 and the ninth lens element 90 can all be made of transparent plastic materials, but the invention is not limited to this. Each lens element has an appropriate refracting power. The optical axis I is the optical axis of the whole zoom lens 1, and the optical axis of each of the lens elements coincides with the optical axis of the zoom lens 1.

In addition, the zoom lens I also includes an aperture stop 2, which is arranged at an appropriate position. In FIG. 6A, the aperture stop 2 is arranged between the third lens element 30 and the fourth lens element 40. When light emitted or reflected by an object (not shown) which is located at the object side A1 enters the zoom lens 1 of the present invention, it forms a clear and sharp image on the image plane 4 at the image side A2 after passing through the first lens element 10, the second lens element 20 and the third lens element in sequence, the aperture stop 2, the fourth lens element 40, the fifth lens element 50, the sixth lens element 60, the seventh lens element 70 and the eighth lens element 80 and the filter 3. In various embodiments of the present invention, the filter 3 is arranged between the eighth lens element 80 and the image plane 4, which can be a filter with various suitable functions, for example, the filter 3 may be an infrared cut-off filter (IR cut filter), which is used to prevent infrared rays in the imaging ray from being transmitted to the image plane 4 to affect the imaging quality.

Each lens element in the zoom lens 1 of the present invention has an object-side surface facing toward the object side A1 as well as an image-side surface facing toward the image side A2. For example, the first lens element 10 has an object-side surface 11 and an image-side surface 12; the second lens element 20 has an object-side surface 21 and an image-side surface 22; the third lens element 30 has an object-side surface 31 and an image-side surface 32; the fourth lens element 40 has an object-side surface 41 and an image-side surface 42; the fifth lens element 50 has an object-side surface 51 and an image-side surface 52; the sixth lens element 60 has an object-side surface 61 and an image-side surface 62; the seventh lens element 70 has an object-side surface 71 and an image-side surface 72; the eighth lens element 80 has an object-side surface 81 and an image-side surface 82; and the ninth lens element 90 has an object-side surface 91 and an image-side surface 92. In addition, each object-side surface and image-side surface in the zoom lens 1 of the present invention has an optical axis region and a periphery region.

Each lens element in the zoom lens 1 of the present invention further has a thickness T along the optical axis I. For example, the first lens element 10 has a first lens element thickness T1, the second lens element 20 has a second lens element thickness T2, the third lens element 30 has a third lens element thickness T3, the fourth lens element 40 has a fourth lens element thickness T4, the fifth lens element 50 has a fifth lens element thickness T5, the sixth lens element 60 has a sixth lens element thickness T6, the seventh lens element 70 has a seventh lens element thickness T7, the eighth lens element 80 has an eighth lens element thickness T8, the ninth lens element 90 has an ninth lens element thickness T9. ALT is the sum of the thicknesses of all of the lens elements in the zoom lens 1 of the present invention along the optical axis I. Therefore, in some embodiments, if the zoom lens 1 includes eight lens elements, ALT=T1+T2+T3+T4+T5+T6+T7+T8. In other embodiments, if the zoom lens 1 includes nine lens elements,

$$ALT = T 1 + T 2 + T 3 + T 4 + T 5 + T 6 + T 7 + T 8 + T 9.$$

Other parameters that may be disclosed in the present invention listed below are defined as follows:
fw is the effective focal length of the zoom lens 1 in the wide-angle state (short-focus); Fnow is the f-number of the zoom lens 1 in the wide-angle state;
   HFOVw is the half field of view (the maximum half field of view) of the zoom lens 1 in the wide-angle state;
ft is the effective focal length of the zoom lens 1 in the telephoto (long-focus) state; Fnot is the f-number of the zoom lens 1 in the telephoto state;
   HFOVt is the half viewing angle (a maximum half field of view) of the zoom lens 1 in the telephoto state;
   ImgH is the maximum image height of the zoom lens;
fG1 is the focal length of the first lens group G1;
fG2 is the focal length of the second lens group G2;
fG3 is the focal length of the third lens group G3;
   D1 is the first adjustable air gap, that is, the air gap between the first lens group G1 and the aperture stop 2 along the optical axis I;
   D2 is the second adjustable air gap, that is, the air gap between the second lens group G2 and the third lens group G3 along the optical axis I;
   D3 is the third adjustable air gap, that is, the air gap between the lens element closest to the image side A2 (it may be the eighth lens element 80 or the ninth lens element 90 according to different embodiments) and the filter 3 along the optical axis I;
   G12 is the air gap between the first lens element 10 and the second lens element 20 along the optical axis I, which is also the distance from the image-side surface 12 of the first lens element 10 to the object-side surface 21 of the second lens element 20 along the optical axis I;
   G23 is the air gap between the second lens element 20 and the third lens element 30 along the optical axis I, which is also the distance from the image-side surface 22 of the second lens element 20 to the object-side surface 31 of the third lens element 30 along the optical axis I;
   G34 is the air gap between the third lens element 30 and the fourth lens element 40 along the optical axis I, which is also the distance from the image-side surface 32 of the third lens element 30 to the object-side surface 41 of the fourth lens element 40 along the optical axis I;
   G45 is the air gap between the fourth lens element 40 and the fifth lens element 50 along the optical axis I, which is also the distance from the image-side surface 42 of the fourth lens element 40 to the object-side surface 51 of the fifth lens element 50 along the optical axis I;
   G56 is the air gap between the fifth lens element 50 and the sixth lens element 60 along the optical axis I, which is also the distance from the image-side surface 52 of the fifth lens element 50 to the object-side surface 61 of the sixth lens element 60 along the optical axis I;
   G67 is the air gap between the sixth lens element 60 and the seventh lens element 70 along the optical axis I, which is also the distance from the image-side surface 62 of the sixth lens element 60 to the object-side surface 71 of the seventh lens element 70 along the optical axis I;
   G78 is the air gap between the seventh lens element 70 and the eighth lens element 80 along the optical axis I, which is also the distance from the image-side surface 72 of the seventh lens element 70 to the object-side surface 81 of the eighth lens element 80 along the optical axis I;
   G89 is the air gap between the eighth lens element 80 and the ninth lens element 90 along the optical axis I, which is also the distance from the image-side surface 82 of the eighth lens element 80 to the object-side surface 91 of the ninth lens element 90 along the optical axis I;
   G8F is the air gap between the eighth lens element 80 and the filter 3 along the optical axis I;
   G9F is the air gap between the ninth lens element 90 and the filter 3 along the optical axis I;
   TF is the thickness of the filter 3 along the optical axis I;
   GFP is the air gap between the filter 3 and the image plane 4 along the optical axis I;
   ER11 is the effective radius of the object-side surface 11 of the first lens element 10, in other words, the optical boundary of the object-side surface 11 of the first lens element 10;
   ER12 is the effective radius of the image-side surface 12 of the first lens element 10, in other words, the optical boundary of the image-side surface 12 of the first lens element 10;
   ER21 is the effective radius of the object-side surface 21 of the second lens element 20, in other words, the optical boundary of the object-side surface 21 of the second lens element 20;
   ER22 is the effective radius of the image-side surface 22 of the second lens element 20, in other words, the optical boundary of the image-side surface 22 of the second lens element 20;
   ER31 is the effective radius of the object-side surface 31 of the third lens element 30, in other words, the optical boundary of the object-side surface 31 of the third lens element 30;
   ER32 is the effective radius of the image-side surface 32 of the third lens element 30, in other words, the optical boundary of the image-side surface 32 of the third lens element 30;
   ER41 is the effective radius of the object-side surface 41 of the fourth lens element 40, in other words, the optical boundary of the object-side surface 41 of the fourth lens element 40;
   ER42 is the effective radius of the image-side surface 42 of the fourth lens element 40, in other words, the optical boundary of the image-side surface 42 of the fourth lens element 40;
   ER51 is the effective radius of the object-side surface 51 of the fifth lens element 50, in other words, the optical boundary of the object-side surface 51 of the fifth lens element 50;
   ER52 is the effective radius of the image-side surface 52 of the fifth lens element 50, in other words, the optical boundary of the image-side surface 52 of the fifth lens element 50;
   ER61 is the effective radius of the object-side surface 61 of the sixth lens element 60, in other words, the optical boundary of the object-side surface 61 of the sixth lens element 60;
   ER62 is the effective radius of the image-side surface 62 of the sixth lens element 60, in other words, the optical boundary of the image-side surface 62 of the sixth lens element 60;
   ER71 is the effective radius of the object-side surface 71 of the seventh lens element 70, in other words, the optical boundary of the object-side surface 71 of the seventh lens element 70;
   ER72 is the effective radius of the image-side surface 72 of the seventh lens element 70, in other words, the optical boundary of the image-side surface 72 of the seventh lens element 70;
   ER81 is the effective radius of the object-side surface 81 of the eighth lens element 80, in other words, the optical boundary of the object-side surface 81 of the eighth lens element 80;
   ER82 is the effective radius of the image-side surface 82 of the eighth lens element 80, in other words, the optical boundary of the image-side surface 82 of the eighth lens element 80;
   ER91 is the effective radius of the object-side surface 91 of the ninth lens element 90, in other words, the optical boundary of the object-side surface 91 of the ninth lens element 90;
   ER92 is the effective radius of the image-side surface 92 of the ninth lens element 90, in other words, the optical boundary of the image-side surface 92 of the ninth lens element 90;
   ERmax is the maximum effective radius of all lens elements;
   ERmin is the minimum effective radius of all lens elements;
   Gall is the sum of the air gaps of all lens elements of the zoom lens 1 along the optical axis I plus the distance from the image-side surface of the lens element closest to the image side to the image plane 4, in other words, the sum of the air gaps of all lens elements of the zoom lens 1 along the optical axis I plus the back focal length. That is, in some embodiments, if the zoom lens 1 has eight lens elements, Gall is the sum of G12, G23, G34, G45, G56, G67, G78, G8F, TF and GFP. In other embodiments, if the zoom lens 1 has nine lens elements, Gall is the sum of G12, G23, G34, G45, G56, G67, G78, G89, G9F, TF and GFP;
   TTL is the distance from the object-side surface 11 of the first lens element 10 to the image plane 4 along the optical axis I, in other words, the system length of the zoom lens 1;
f35t is the effective focal length of 35 mm equivalent focal length format of zoom lens 1 in the telephoto state;
f35w is the effective focal length of the 35 mm equivalent focal length format of the zoom lens 1 in the wide-angle state;
Δf is the difference of the effective focal length of the zoom lens 1 between the telephoto state and the wide-angle state, that is, the difference between ft and fw;
ΔFno is the difference of the f-number of the zoom lens 1 in the telephoto state and the wide-angle state, that is, the difference between Fnot and Fnow;
ΔHFOV is the difference of the half field of view of the zoom lens 1 between the telephoto state and the wide-angle state, that is, the difference between HFOVt and HFOVw;
   EPDt is the entrance pupil diameter of the zoom lens 1 in the telephoto state, which is equal to the effective focal length of the zoom lens 1 in the telephoto state divided by the f-number;
   EPDw is the entrance pupil diameter of the zoom lens 1 in the wide-angle state, which is equal to the effective focal length of the zoom lens 1 in the wide-angle state divided by the f-number;
   DG1 is the length of the first lens group G1 along the optical axis I;
   DG2 is the length of the second lens group G2 along the optical axis I;
   DG3 is the length of the third lens group G3 along the optical axis I;
   D71t82 is the distance from the object-side surface 71 of the seventh lens element 70 to the image-side surface 82 of the eighth lens element 80 along the optical axis I;
f1 is the focal length of the first lens element 10;
f2 is the focal length of the second lens element 20;
f3 is the focal length of the third lens element 30;
f4 is the focal length of the fourth lens element 40;
f5 is the focal length of the fifth lens element 50;
f6 is the focal length of the sixth lens element 60;
f7 is the focal length of the seventh lens element 70;
f8 is the focal length of the eighth lens element 80;
f9 is the focal length of the ninth lens element 90;
n1 is the refractive index of the first lens element 10;
n2 is the refractive index of the second lens element 20;
n3 is the refractive index of the third lens element 30;
n4 is the refractive index of the fourth lens element 40;
n5 is the refractive index of the fifth lens element 50;
n6 is the refractive index of the sixth lens element 60;
n7 is the refractive index of the seventh lens element 70;
n8 is the refractive index of the eighth lens element 80;
n9 is the refractive index of the ninth lens element 90;
   V1 is the Abbe number of the first lens element 10;
   V2 is the Abbe number of the second lens element 20;
   V3 is the Abbe number of the third lens element 30;
   V4 is the Abbe number of the fourth lens element 40;
   V5 is the Abbe number of the fifth lens element 50;
   V6 is the Abbe number of the sixth lens element 60;
   V7 is the Abbe number of the seventh lens element 70;
   V8 is the Abbe number of the eighth lens element 80; and
   V9 is the Abbe number of the ninth lens element 90.

### First Embodiment

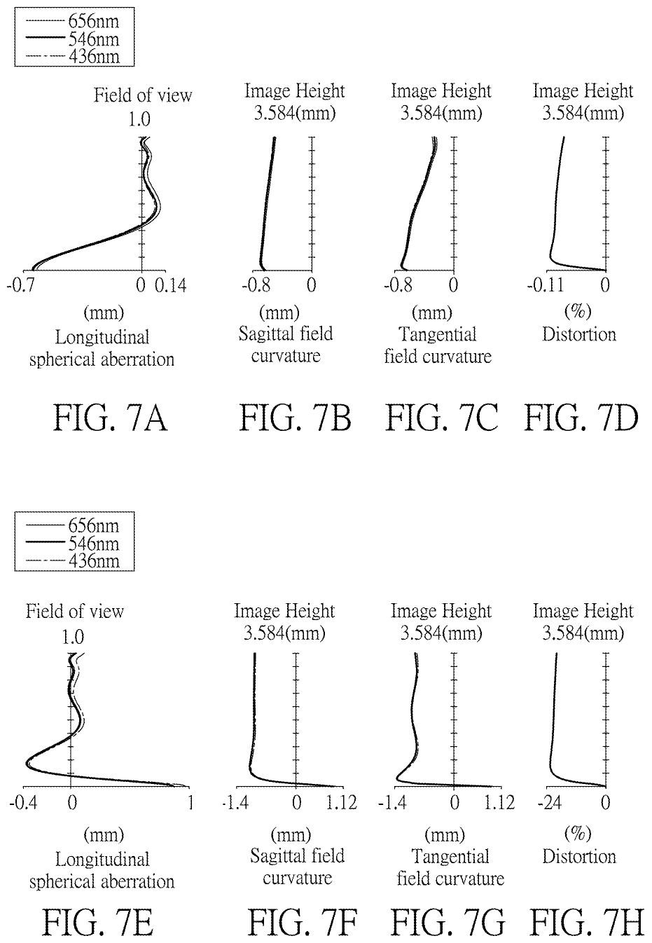

Please refer to FIGS. 6A and 6B. FIG. 6A is a schematic diagram showing the wide-angle state of the first embodiment of the zoom lens of the present invention. FIG. 6B shows a schematic view in the telephoto state of the first embodiment of the zoom lens of the present invention. FIGS. 6A and 6B show the first embodiment of the zoom lens 1 of the present invention. Please refer to FIGS. 7A-7H, FIG. 7A illustrates the longitudinal spherical aberration on the image plane in the wide-angle state of the first embodiment, FIG. 7B illustrates the field curvature aberration on the sagittal direction in the wide-angle state of the first embodiment, FIG. 7C illustrates the field curvature aberration on the tangential direction in the wide-angle state of the first embodiment, FIG. 7D illustrates the distortion in the wide-angle state of the first embodiment, FIG. 7E illustrates the longitudinal spherical aberration on the image plane in the telephoto state of the first embodiment, FIG. 7F illustrates the field curvature aberration on the sagittal direction in the telephoto state of the first embodiment, FIG. 7G illustrates the field curvature aberration on the tangential direction in the telephoto state of the first embodiment, and FIG. 7H illustrates the distortion in the telephoto state of the first embodiment. The Y axis of the spherical aberration in each embodiment is “field of view” for 1.0. The Y axis of the astigmatic field and the distortion in each embodiment stands for “maximum image height” (ImgH), which is 3.584 mm.

The zoom lens 1 of the first embodiment is mainly composed of an aperture stop 2, a first lens group G1, a second lens group G2 and a third lens group G3, and an image plane 4. There are total eight lens elements with refracting power in the first lens group G1, the second lens group G2 and the third lens group G3, namely, the first lens element 10, the second lens element 20, the third lens element 30, the fourth lens element 40, the fifth lens element 50 and the sixth lens element 60, the seventh lens element 70 and the eighth lens element 80. The first lens group G1 includes the first lens element 10, the second lens element 20 and the third lens element 30, the second lens group G2 includes the fourth lens element 40 and the fifth lens element 50, and the third lens group G3 includes the sixth lens element 60, the seventh lens element 70 and the eighth lens element 80. The aperture stop 2 of the first embodiment is arranged between the first lens group G1 and the second lens group G2, that is, between the third lens element 30 and the fourth lens element 40.

In this embodiment, the first lens group G1 has positive refracting power, the second lens group G2 has positive refracting power and the third lens group G3 has negative refracting power.

The first lens element 10 has positive refracting power. The optical axis region 13 of the object-side surface 11 of the first lens element 10 is convex, the periphery region 14 of the object-side surface 11 of the first lens element 10 is convex, the optical axis region 16 of the image-side surface 12 of the first lens element 10 is concave, the periphery region 17 of the image-side surface 12 of the first lens element 10 is concave. Both the object-side surface 11 and the image-side surface 12 of the first lens element 10 are aspheric surfaces, but it is not limited thereto.

The second lens element 20 has positive refracting power. The optical axis region 23 of the object-side surface 21 of the second lens element 20 is convex, the periphery region 24 of the object-side surface 21 of the second lens element 20 is convex, the optical axis region 26 of the image-side surface 22 of the second lens element 20 is concave, the periphery region 27 of the image-side surface 22 of the second lens element 20 is concave. Both the object-side surface 21 and the image-side surface 22 of the second lens element 20 are aspheric surfaces, but it is not limited thereto.

The third lens element 30 has negative refracting power. The optical axis region 33 of the object-side surface 31 of the third lens element 30 is convex, the periphery region 34 of the object-side surface 31 of the third lens element 30 is concave, the optical axis region 36 of the image-side surface 32 of the third lens element 30 is concave, the periphery region 37 of the image-side surface 32 of the third lens element 30 is convex. Both the object-side surface 31 and the image-side surface 32 of the third lens element 30 are aspheric surfaces, but it is not limited thereto.

The fourth lens element 40 has positive refracting power. The optical axis region 43 of the object-side surface 41 of the fourth lens element 40 is convex, the periphery region 44 of the object-side surface 41 of the fourth lens element 40 is convex, the optical axis region 46 of the image-side surface 42 of the fourth lens element 40 is convex, the periphery region 47 of the image-side surface 42 of the fourth lens element 40 is convex. Both the object-side surface 41 and the image-side surface 42 of the fourth lens element 40 are aspheric surfaces, but it is not limited thereto.

The fifth lens element 50 has negative refracting power, the optical axis region 53 of the object-side surface 51 of the fifth lens element 50 is concave, the periphery region 54 of the object-side surface 51 of the fifth lens element 50 is concave, the optical axis region 56 of the image-side surface 52 of the fifth lens element 50 is convex, the periphery region 57 of the image-side surface 52 of the fifth lens element 50 is convex. Both the object-side surface 51 and the image-side surface 52 of the fifth lens element 50 are aspheric surfaces, but it is not limited thereto.

The sixth lens element 60 has negative refracting power, the optical axis region 63 of the object-side surface 61 of the sixth lens element 60 is concave, the periphery region 64 of the object-side surface 61 of the sixth lens element 60 is concave, the optical axis region 66 of the image-side surface 62 of the sixth lens element 60 is concave, the periphery region 67 of the image-side surface 62 of the sixth lens element 60 is concave. Both the object-side surface 61 and the image-side surface 62 of the sixth lens element 60 are aspheric surfaces, but it is not limited thereto.

The seventh lens element 70 has positive refracting power, the optical axis region 73 of the object-side surface 71 of the seventh lens element 70 is concave, the periphery region 74 of the object-side surface 71 of the seventh lens element 70 is convex, the optical axis region 76 of the image-side surface 72 of the seventh lens element 70 is convex, the periphery region 77 of the image-side surface 72 of the seventh lens element 70 is concave. Both the object-side surface 71 and the image-side surface 72 of the seventh lens element 70 are aspheric surfaces, but it is not limited thereto.

The eighth lens element 80 has negative refracting power, the optical axis region 83 of the object-side surface 81 of the eighth lens element 80 is concave, the periphery region 84 of the object-side surface 81 of the eighth lens element 80 is concave, and the optical axis region 86 of the image-side surface 82 of the eighth lens element 80 is concave, the periphery region 87 of the image-side surface 82 of the eighth lens element 80 is convex. Both the object-side surface 81 and the image-side surface 82 of the eighth lens element 80 are aspheric surfaces, but it is not limited thereto.

In the zoom lens 1 of this embodiment, from the first lens element 10 to the eighth lens element 80, all the object-side surfaces Nov. 21, 1931/41/51/61/71/81 and the image-side surfaces Dec. 22, 1932/42/52/62/72/82 are aspheric surfaces, but not limited thereto. In other subsequent embodiments, if the zoom lens 1 includes the ninth lens element 90, its object-side surface 91 and image-side surface 92 are also aspheric surfaces. If the object-side surface or image-side surface of the lens of the present invention is aspheric surface, these aspheric surfaces are defined by the following formula:

$$Z ( Y ) = \frac{{Y}^{2}}{R} / ( 1 + \sqrt{1 - ( 1 + K ) \frac{{Y}^{2}}{{R}^{2}}} ) + {\sum }_{i = 1}^{n} {a}_{i} \times {Y}^{i}$$

In which:
Y represents a perpendicular distance from a point on the aspheric surface to the optical axis;
Z represents the depth of an aspheric surface (the perpendicular distance between the point of the aspheric surface at a distance Y from the optical axis and the tangent plane of the vertex along the optical axis of the aspheric surface);
R represents the radius of curvature of the lens element surface;
K is a conic constant; and
aᵢ is the aspheric coefficient of the i^{th} order, in which the a₂ coefficient of each embodiment is 0, therefore, the a₂ coefficient is not indicated in the following aspheric surface data tables.

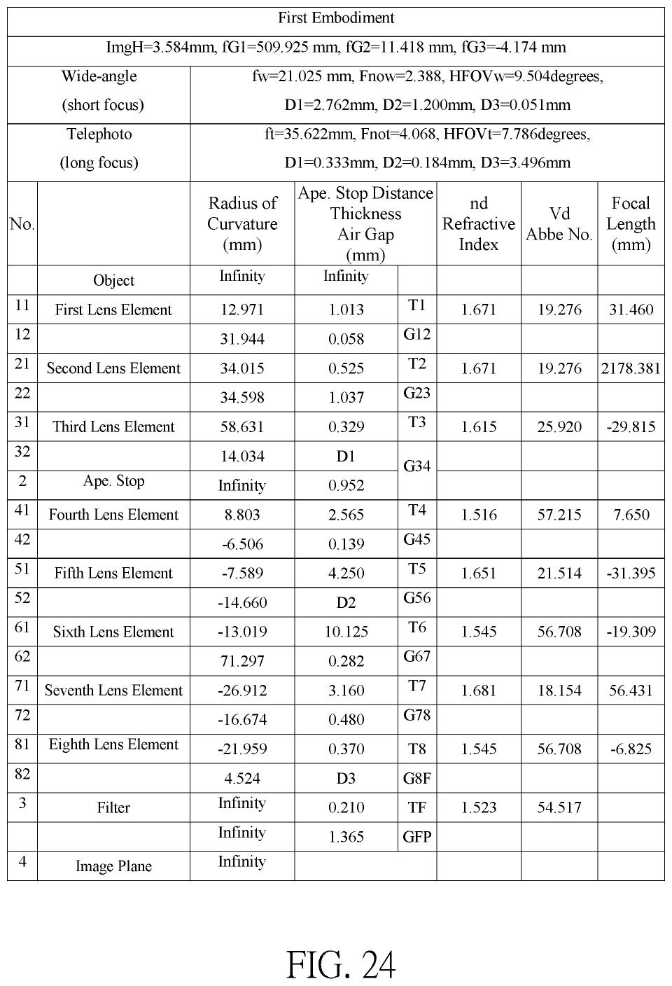

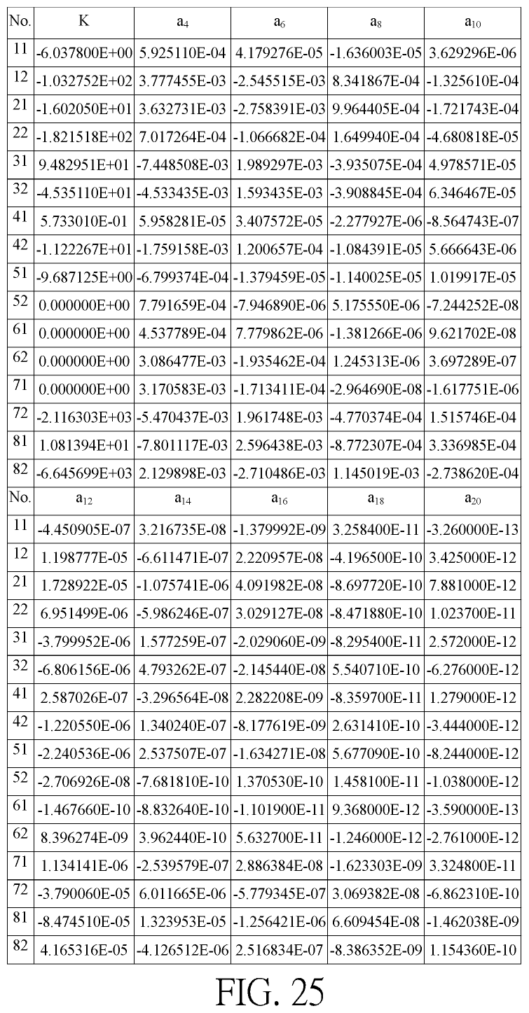

The optical data of the zoom lens 1 system of the first embodiment are shown in FIG. 24, and the aspheric surface data are shown in FIG. 25. In the zoom lens 1 system of the following embodiment, fG1 is the focal length of the first lens group G1, fG2 is the focal length of the second lens group G2, fG3 is the focal length of the third lens group G3, fw is the effective focal length of the zoom lens 1 in the wide-angle state (short-focus), and Fnow is the f-number of the zoom lens 1 in the wide-angle state. HFOVw is the half field of view (the maximum half field of view) of the zoom lens 1 in the wide-angle state, ft is the effective focal length of the zoom lens 1 in the telephoto (long-focus) state, Fnot is the f-number of the zoom lens 1 in the telephoto state, and HFOVt is the half field of view (the maximum half field of view) of the zoom lens 1 in the telephoto state. D1 is the first adjustable air gap, that is, the air gap between the first lens group G1 and the aperture stop 2 along the optical axis I; D2 is the second adjustable air gap, that is, the air gap between the second lens group G2 and the third lens group G3 along the optical axis I; D3 is the third adjustable air gap, that is, the air gap between the lens element closest to the image side A2 (it may be the eighth lens element 80 or the ninth lens element 90 according to different embodiments) and the filter 3 along the optical axis I. The unit of the image height, radius of curvature, thickness and focal length of the zoom lens 1 are all millimeters (mm). In this embodiment, ImgH=3.584 mm, fG1=509.925 mm, fG2=11.418 mm, fG3=−4.174 mm. When the zoom lens 1 is in the wide-angle (short-focus) state, fw=21.025 mm, Fnow=2.388, HFOVw=9.504 degrees, D1=2.762 mm, D2=1.200 mm, D3=0.051 mm. When the zoom lens 1 is in the telephoto (long-focus) state, ft=35.622 mm, Fnot=4.068, HFOVt=7.786 degrees, D1=0.333 mm, D2=0.184 mm, D3=3.496 mm.

### Second Embodiment

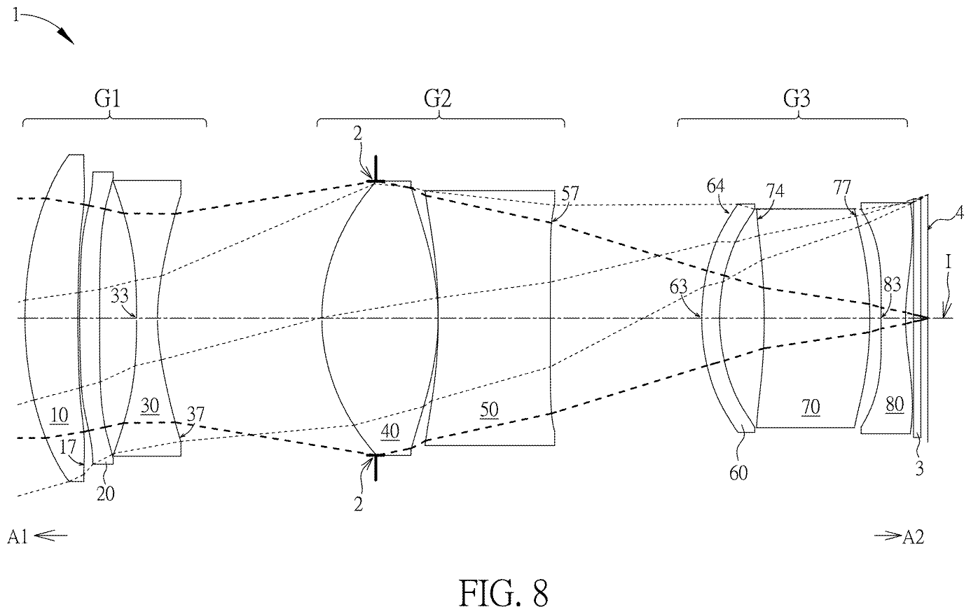

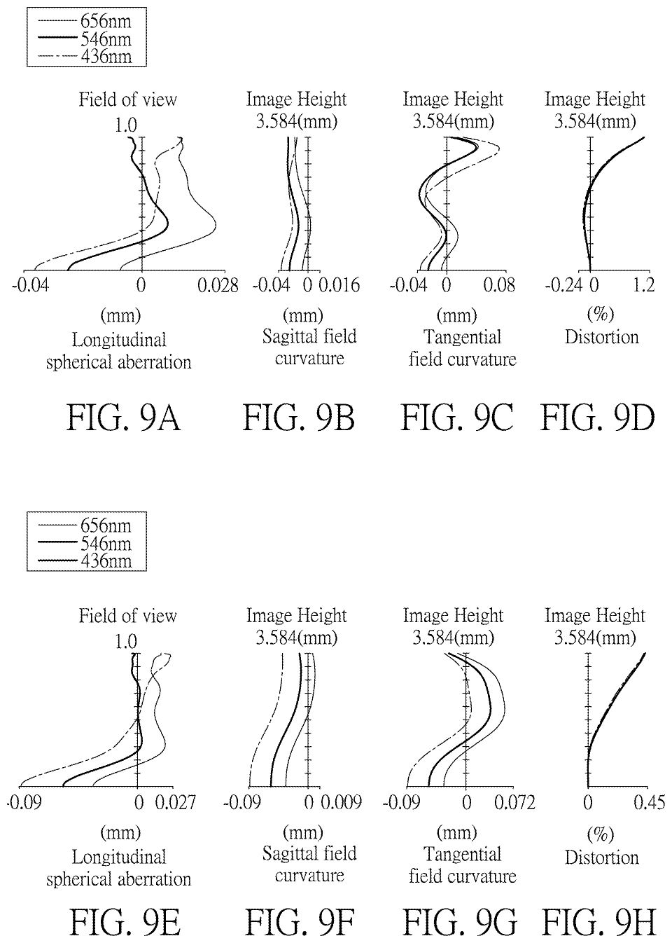

Please refer to FIG. 8 which illustrates the second embodiment of the zoom lens 1 of the present invention. It is noted that from the second embodiment to the following embodiments, in order to simplify the figures, only the components different from what the first embodiment has, and the basic lens elements will be labeled in figures. Other components that are the same as what the first embodiment has, such as the object-side surface, the image-side surface, the portion in a vicinity of the optical axis and the portion in a vicinity of its periphery will be omitted in the following embodiments. Please refer to FIGS. 9A-9H, FIG. 9A illustrates the longitudinal spherical aberration on the image plane in the telephoto state of the second embodiment, FIG. 9B illustrates the field curvature aberration on the sagittal direction in the telephoto state of the second embodiment, FIG. 9C illustrates the field curvature aberration on the tangential direction in the telephoto state of the second embodiment, FIG. 9D illustrates the distortion in the telephoto state of the second embodiment, FIG. 9E illustrates the longitudinal spherical aberration on the image plane in the wide-angle state of the second embodiment, FIG. 9F illustrates the field curvature aberration on the sagittal direction in the wide-angle state of the second embodiment, FIG. 9G illustrates the field curvature aberration on the tangential direction in the wide-angle state of the second embodiment, FIG. 9H illustrates the distortion in the wide-angle state of the second embodiment. The components in this embodiment are similar to those in the first embodiment, but the optical data such as the lens element refracting power, the radius of curvature, the lens element thickness, the aspheric surface or the back focal length in this embodiment are different from the optical data in the first embodiment. In addition, in this embodiment, the first lens group G1 has negative refracting power, the periphery region 17 of the image-side surface 12 of the first lens element 10 is convex, the optical axis region 33 of the object-side surface 31 of the third lens element 30 is concave, the periphery region 37 of the image-side surface 32 of the third lens element 30 is concave, the periphery region 57 of the image-side surface 52 of the fifth lens element 50 is concave, the optical axis region 63 of the object-side surface 61 of the sixth lens element 60 is convex, the periphery region 64 of the object-side surface 61 of the sixth lens element 60 is convex, the periphery region 74 of the object-side surface 71 of the seventh lens element 70 is concave, the periphery region 77 of the image-side surface 72 of the seventh lens element 70 is convex, and the optical axis region 83 of the object-side surface 81 of the eighth lens element 80 is convex.

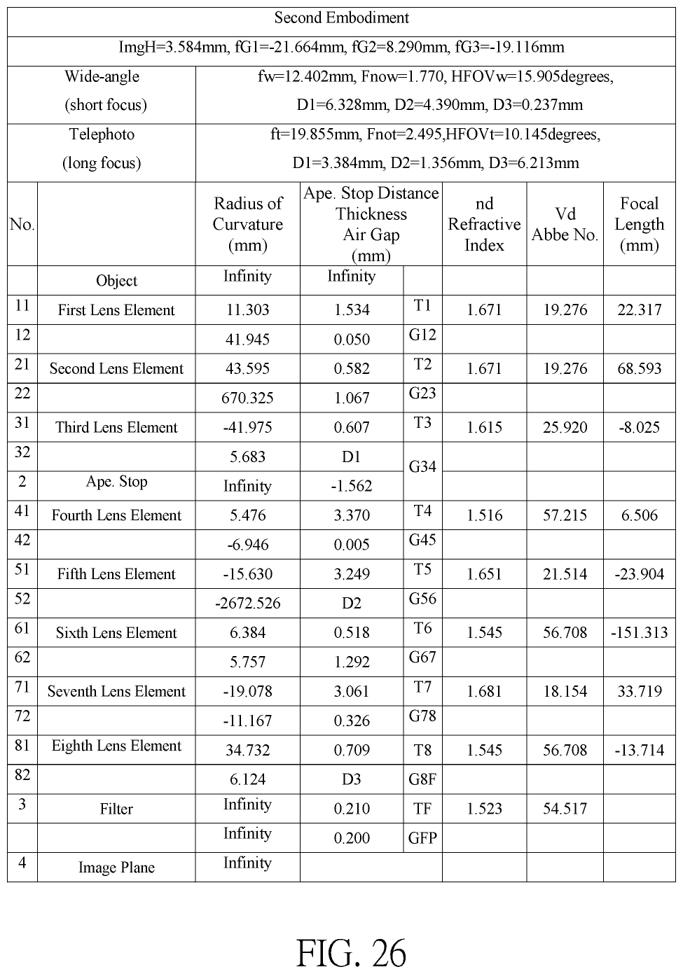

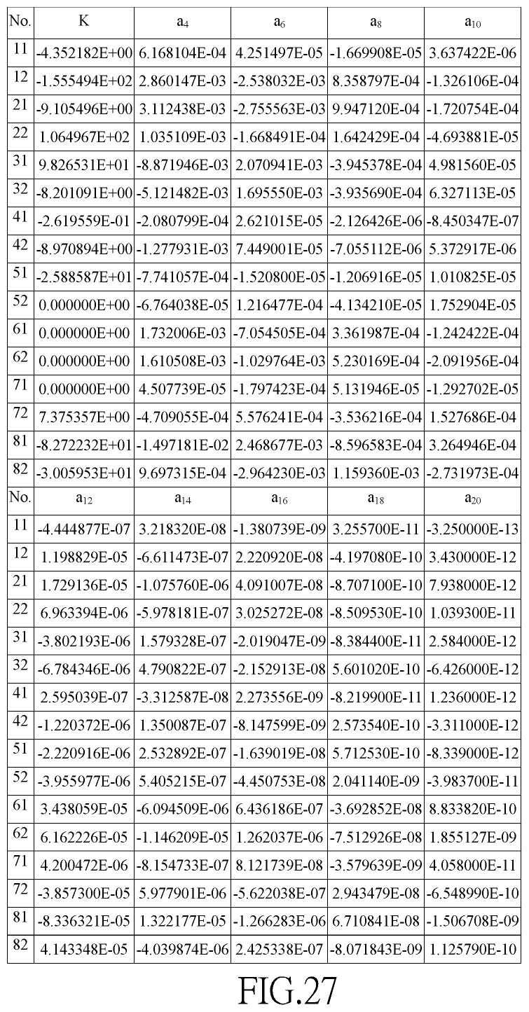

The optical data of the second embodiment are shown in FIG. 26, and the aspheric surface data are shown in FIG. 27. In this embodiment, ImgH=3.584 mm, fG1=−21.664 mm, fG2=8.290 mm, fG3=−19.116 mm. When the zoom lens 1 is in the wide-angle (short-focus) state, fw=12.402 mm, Fnow=1.770, HFOVw=15.905 degrees, D1=6.328 mm, D2=4.390 mm, D3=0.237 mm. When the zoom lens 1 is in the telephoto (long-focus) state, ft=19.855 mm, Fnot=2.495, HFOVt=10.145 degrees, D1=3.384 mm, D2=1.356 mm, D3=6.213 mm.

In addition, this embodiment has the following advantages compared with the first embodiment: 1. The longitudinal spherical aberration in the wide-angle state of this embodiment is better than the longitudinal spherical aberration in the wide-angle state of the first embodiment; 2. The field curvature aberration on the sagittal direction in the wide-angle state of this embodiment is better than the field curvature aberration on the sagittal direction in the wide-angle state of the first embodiment; 3. The field curvature aberration on the tangential direction in the wide-angle state of this embodiment is better than the field curvature aberration on the tangential direction in the wide-angle state of the first embodiment; 4. The distortion aberration in the wide-angle state of this embodiment is better than the distortion aberration in the wide-angle state of the first embodiment; 5. The half field of view in the wide-angle state of this embodiment is larger than the half field of view in the wide-angle state of the first embodiment; 6. The longitudinal spherical aberration in the telephoto state of this embodiment is better than the longitudinal spherical aberration in the telephoto state of the first embodiment; 7. The field curvature aberration on the sagittal direction in the telephoto state of this embodiment is better than the field curvature aberration on the sagittal direction in the telephoto state of the first embodiment; 8. The field curvature aberration on the tangential direction in the telephoto state of this embodiment is better than the field curvature aberration on the tangential direction in the telephoto state of the first embodiment; 9. The distortion aberration in the telephoto state of this embodiment is better than the distortion aberration in the telephoto state of the first embodiment.

### Third Embodiment

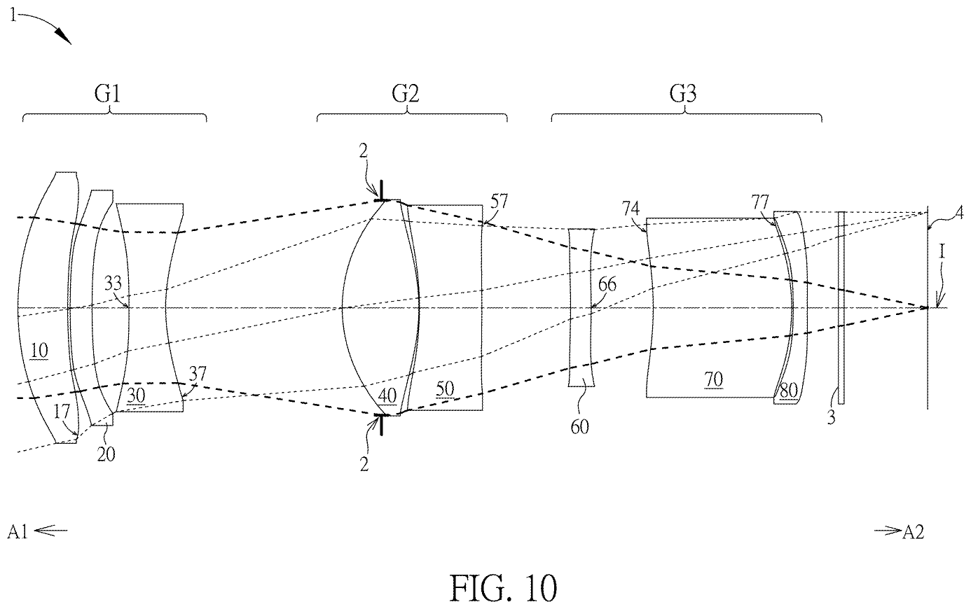

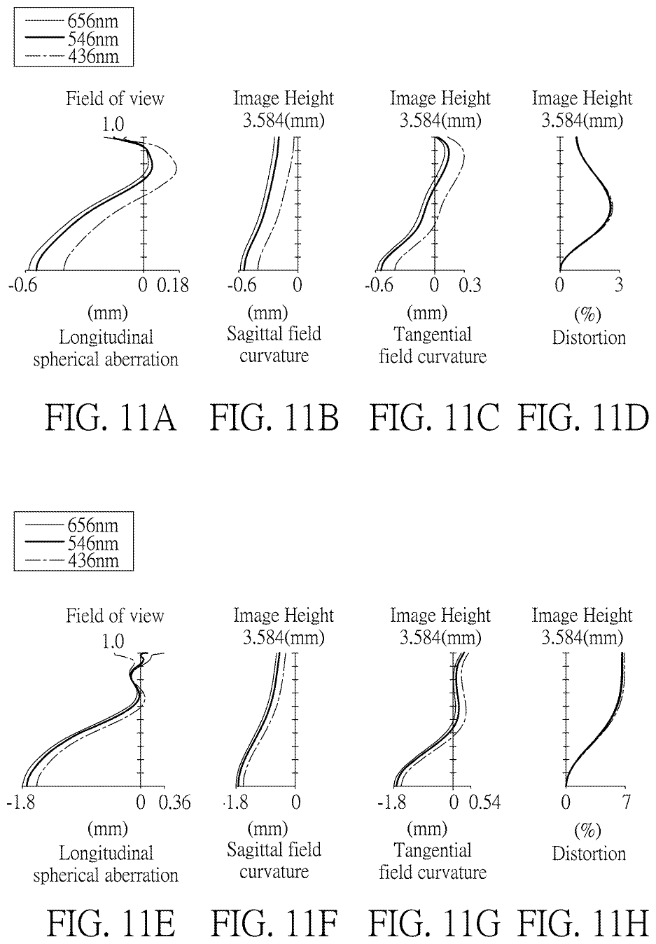

Please refer to FIG. 10 which illustrates the third embodiment of the zoom lens 1 of the present invention. Please refer to FIGS. 11A-11H, FIG. 11A illustrates the longitudinal spherical aberration on the image plane in the telephoto state of the third embodiment, FIG. 11B illustrates the field curvature aberration on the sagittal direction in the telephoto state of the third embodiment, FIG. 11C illustrates the field curvature aberration on the tangential direction in the telephoto state of the third embodiment, FIG. 11D illustrates the distortion in the telephoto state of the third embodiment, FIG. 11E illustrates the longitudinal spherical aberration on the image plane in the wide-angle state of the third embodiment, FIG. 11F illustrates the field curvature aberration on the sagittal direction in the wide-angle state of the third embodiment, FIG. 11G illustrates the field curvature aberration on the tangential direction in the wide-angle state of the third embodiment, FIG. 11H illustrates the distortion in the wide-angle state of the third embodiment. The components in this embodiment are similar to those in the first embodiment, but the optical data such as the lens element refracting power, the radius of curvature, the lens element thickness, the aspheric surface or the back focal length in this embodiment are different from the optical data in the first embodiment. In addition, in this embodiment, the first lens group G1 has negative refracting power, the third lens group G3 has positive refracting power, the periphery region 17 of the image-side surface 12 of the first lens element 10 is convex, the optical axis region 33 of the object-side surface 31 of the third lens element 30 is concave, the periphery region 37 of the image-side surface 32 of the third lens element 30 is concave, the periphery region 57 of the image-side surface 52 of the fifth lens element 50 is concave, and the sixth lens element 60 has positive refracting power. The optical axis region 66 of the image-side surface 62 of the sixth lens element 60 is convex, the periphery region 74 of the object-side surface 71 of the seventh lens element 70 is concave, and the periphery region 77 of the image-side surface 72 of the seventh lens element 70 is convex.

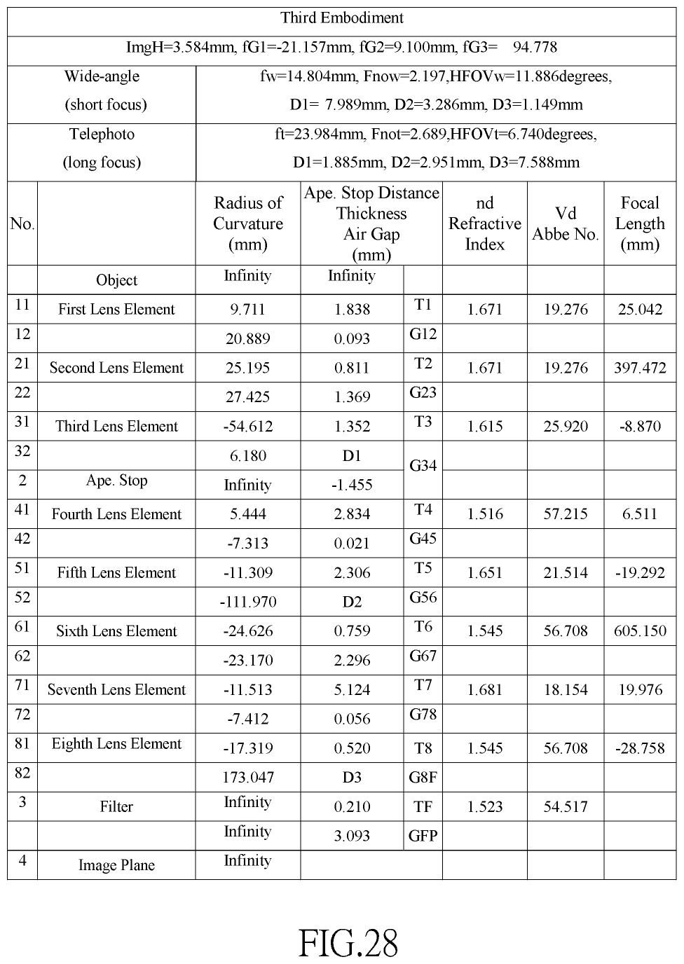

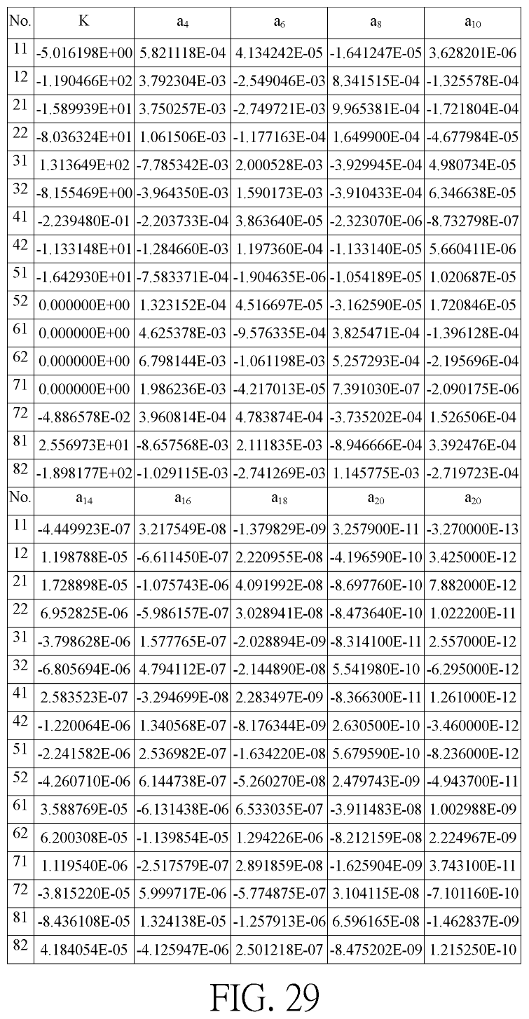

The optical data of the third embodiment are shown in FIG. 28, and the aspheric surface data are shown in FIG. 29. In this embodiment, ImgH=3.584 mm, fG1=−21.157 mm, fG2=9.100 mm, fG3=94.778. When the zoom lens 1 is in the wide-angle (short-focus) state, fw=14.804 mm, Fnow=2.197, HFOVw=11.886 degrees, D1=7.989 mm, D2=3.286 mm and D3=1.149 mm. When the zoom lens 1 is in the telephoto (long-focus) state, ft=23.984 mm, Fnot=2.689, HFOVt=6.740 degrees, D1=1.885 mm, D2=2.951 mm, D3=7.588 mm.

In addition, this embodiment has the following advantages compared with the first embodiment: 1. The longitudinal spherical aberration in the wide-angle state of this embodiment is better than the longitudinal spherical aberration in the wide-angle state of the first embodiment; 2. The field curvature aberration on the sagittal direction in the wide-angle state of this embodiment is better than the field curvature aberration on the sagittal direction in the wide-angle state of the first embodiment; 3. The field curvature aberration on the tangential direction in the wide-angle state of this embodiment is better than the field curvature aberration on the tangential direction in the wide-angle state of the first embodiment; 4. The distortion aberration in the wide-angle state of this embodiment is better than the distortion aberration in the wide-angle state of the first embodiment; 5. The half field of view in the wide-angle state of this embodiment is larger than the half field of view in the wide-angle state of the first embodiment; 6. The distortion aberration in the telephoto state of this embodiment is better than the distortion aberration in the telephoto state of the first embodiment.

### Fourth Embodiment

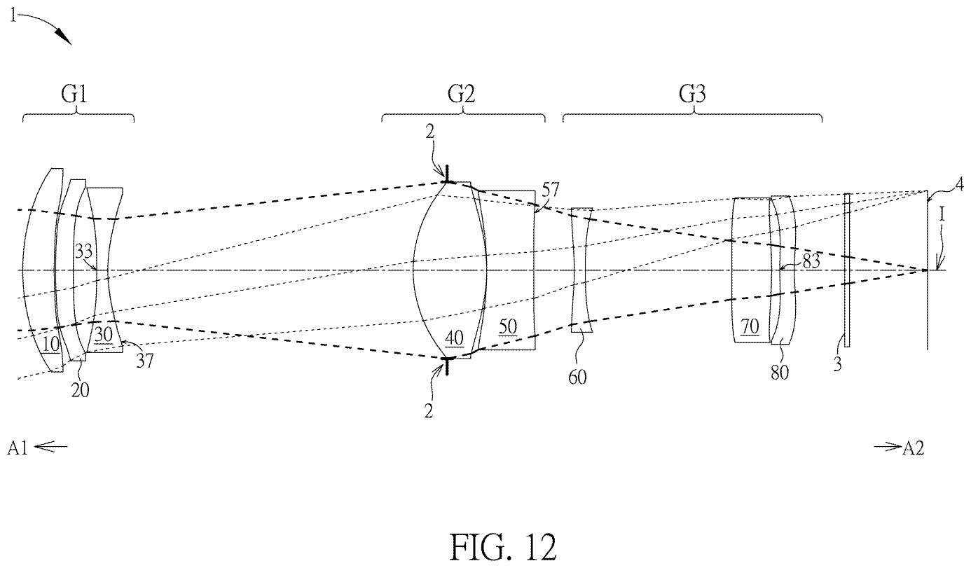

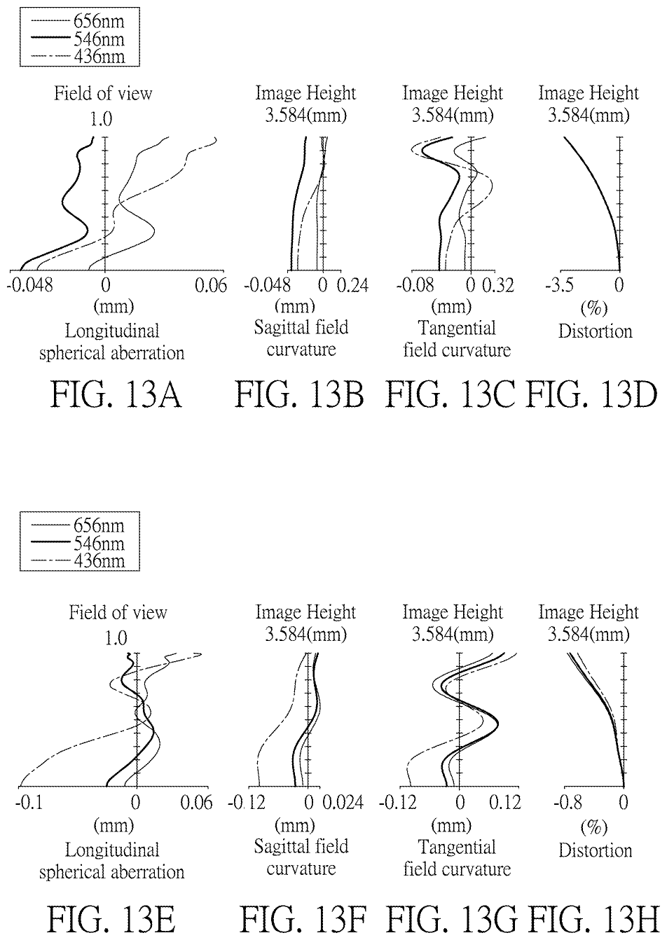

Please refer to FIG. 12 which illustrates the fourth embodiment of the zoom lens 1 of the present invention. Please refer to FIGS. 13A-13H, FIG. 13A illustrates the longitudinal spherical aberration on the image plane in the telephoto state of the fourth embodiment, FIG. 13B illustrates the field curvature aberration on the sagittal direction in the telephoto state of the fourth embodiment, FIG. 13C illustrates the field curvature aberration on the tangential direction in the telephoto state of the fourth embodiment, FIG. 13D illustrates the distortion in the telephoto state of the fourth embodiment, FIG. 13E illustrates the longitudinal spherical aberration on the image plane in the wide-angle state of the fourth embodiment, FIG. 13F illustrates the field curvature aberration on the sagittal direction in the wide-angle state of the fourth embodiment, FIG. 13G illustrates the field curvature aberration on the tangential direction in the wide-angle state of the fourth embodiment, FIG. 13H illustrates the distortion in the wide-angle state of the fourth embodiment. The components in this embodiment are similar to those in the first embodiment, but the optical data such as the lens element refracting power, the radius of curvature, the lens element thickness, the aspheric surface or the back focal length in this embodiment are different from the optical data in the first embodiment. In addition, in this embodiment, the first lens group G1 has negative refracting power, the optical axis region 33 of the object-side surface 31 of the third lens element 30 is concave, the periphery region 37 of the image-side surface 32 of the third lens element 30 is concave, the periphery region 57 of the image-side surface 52 of the fifth lens element 50 is concave, and the optical axis region 83 of the object-side surface 81 of the eighth lens element 80 is convex.

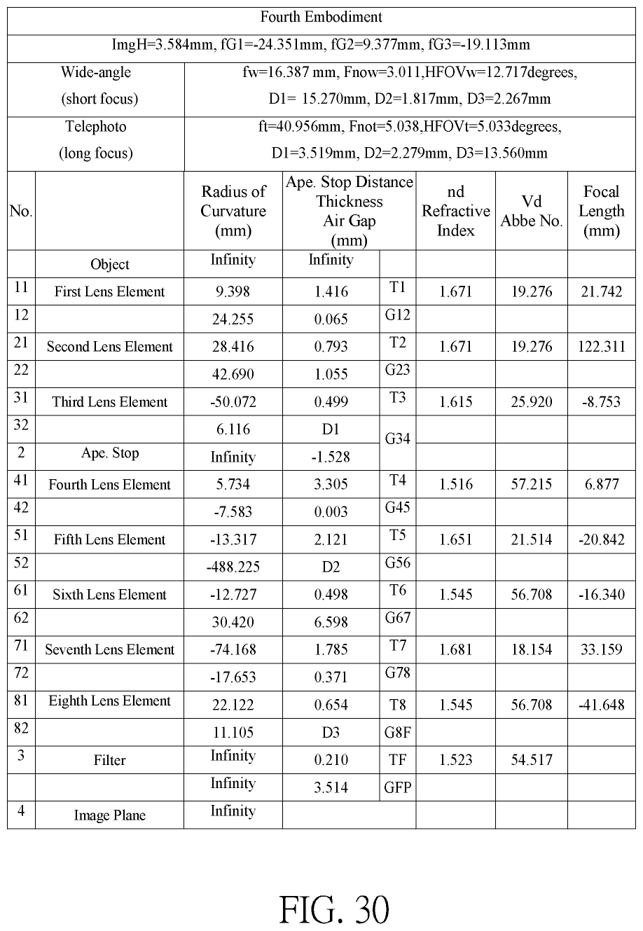

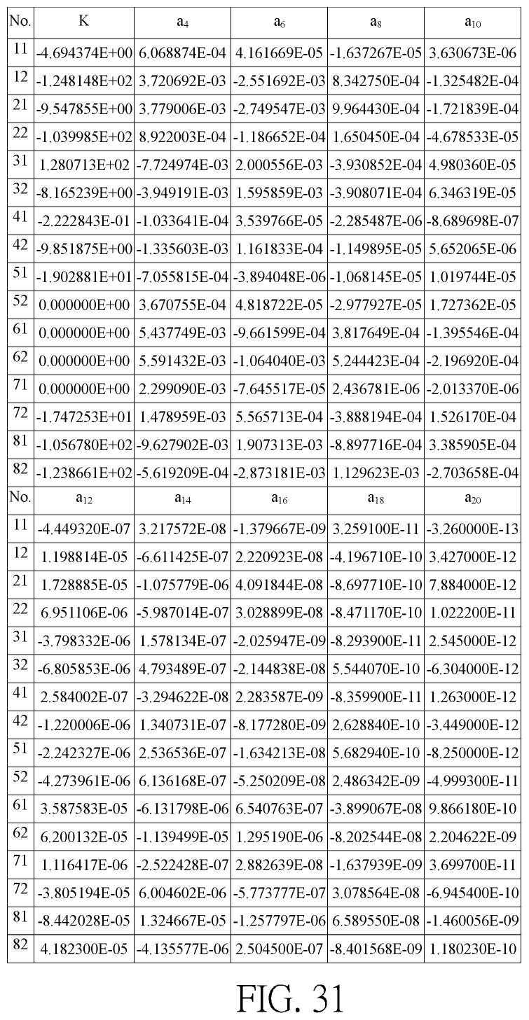

The optical data of the fourth embodiment are shown in FIG. 30, and the aspheric surface data are shown in FIG. 31. In this embodiment, ImgH=3.584 mm, fG1=−24.351 mm, fG2=9.377 mm, fG3=−19.113 mm. When the zoom lens 1 is in the wide-angle (short-focus) state, fw=16.387 mm, Fnow=3.011, HFOVw=12.717 degrees, D1=15.270 mm, D2=1.817 mm, D3=2.267 mm. When the zoom lens 1 is in the telephoto (long-focus) state, ft=40.956 mm, Fnot=5.038, HFOVt=5.033 degrees, D1=3.519 mm, D2=2.279 mm, D3=13.560 mm.

In addition, this embodiment has the following advantages compared with the first embodiment: 1. The longitudinal spherical aberration in the wide-angle state of this embodiment is better than the longitudinal spherical aberration in the wide-angle state of the first embodiment; 2. The field curvature aberration on the sagittal direction in the wide-angle state of this embodiment is better than the field curvature aberration on the sagittal direction in the wide-angle state of the first embodiment; 3. The field curvature aberration on the tangential direction in the wide-angle state of this embodiment is better than the field curvature aberration on the tangential direction in the wide-angle state of the first embodiment; 4. The distortion aberration in the wide-angle state of this embodiment is better than the distortion aberration in the wide-angle state of the first embodiment; 5. The half field of view in the wide-angle state of this embodiment is larger than the half field of view in the wide-angle state of the first embodiment; 6. The longitudinal spherical aberration in the telephoto state of this embodiment is better than the longitudinal spherical aberration in the telephoto state of the first embodiment; 7. The field curvature aberration on the sagittal direction in the telephoto state of this embodiment is better than the field curvature aberration on the sagittal direction in the telephoto state of the first embodiment; 8. The field curvature aberration on the tangential direction in the telephoto state of this embodiment is better than the field curvature aberration on the tangential direction in the telephoto state of the first embodiment; 9. The distortion aberration in the telephoto state of this embodiment is better than the distortion aberration in the telephoto state of the first embodiment.

### Fifth Embodiment

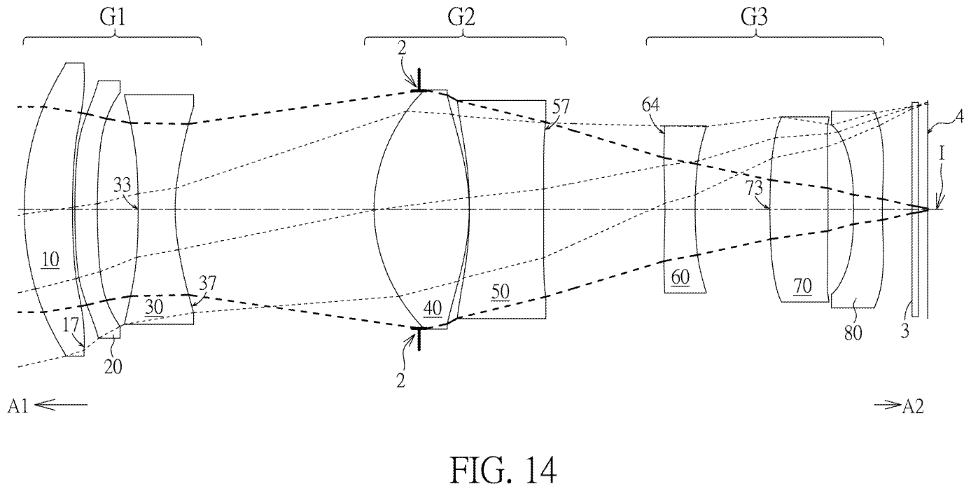

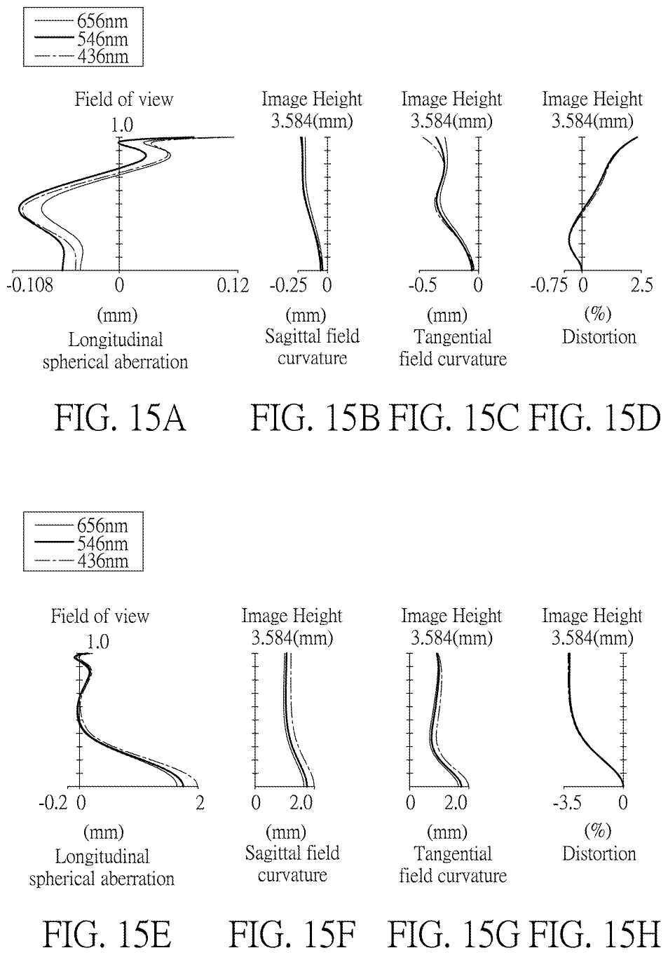

Please refer to FIG. 14 which illustrates the fifth embodiment of the zoom lens 1 of the present invention. Please refer to FIGS. 15A-15H, FIG. 15A illustrates the longitudinal spherical aberration on the image plane in the telephoto state of the fifth embodiment, FIG. 15B illustrates the field curvature aberration on the sagittal direction in the telephoto state of the fifth embodiment, FIG. 15C illustrates the field curvature aberration on the tangential direction in the telephoto state of the fifth embodiment, FIG. 15D illustrates the distortion in the telephoto state of the fifth embodiment, FIG. 15E illustrates the longitudinal spherical aberration on the image plane in the wide-angle state of the fifth embodiment, FIG. 15F illustrates the field curvature aberration on the sagittal direction in the wide-angle state of the fifth embodiment, FIG. 15G illustrates the field curvature aberration on the tangential direction in the wide-angle state of the fifth embodiment, FIG. 15H illustrates the distortion in the wide-angle state of the fifth embodiment. The components in this embodiment are similar to those in the first embodiment, but the optical data such as the lens element refracting power, the radius of curvature, the lens element thickness, the aspheric surface or the back focal length in this embodiment are different from the optical data in the first embodiment. In addition, in this embodiment, the first lens group G1 has negative refracting power, the periphery region 17 of the image-side surface 12 of the first lens element 10 is convex, the optical axis region 33 of the object-side surface 31 of the third lens element 30 is concave, the periphery region 37 of the image-side surface 32 of the third lens element 30 is concave, the periphery region 57 of the image-side surface 52 of the fifth lens element 50 is concave, the periphery region 64 of the object-side surface 61 of the sixth lens element 60 is convex, and the optical axis region 73 of the object-side 71 of the seventh lens element 70 is convex.

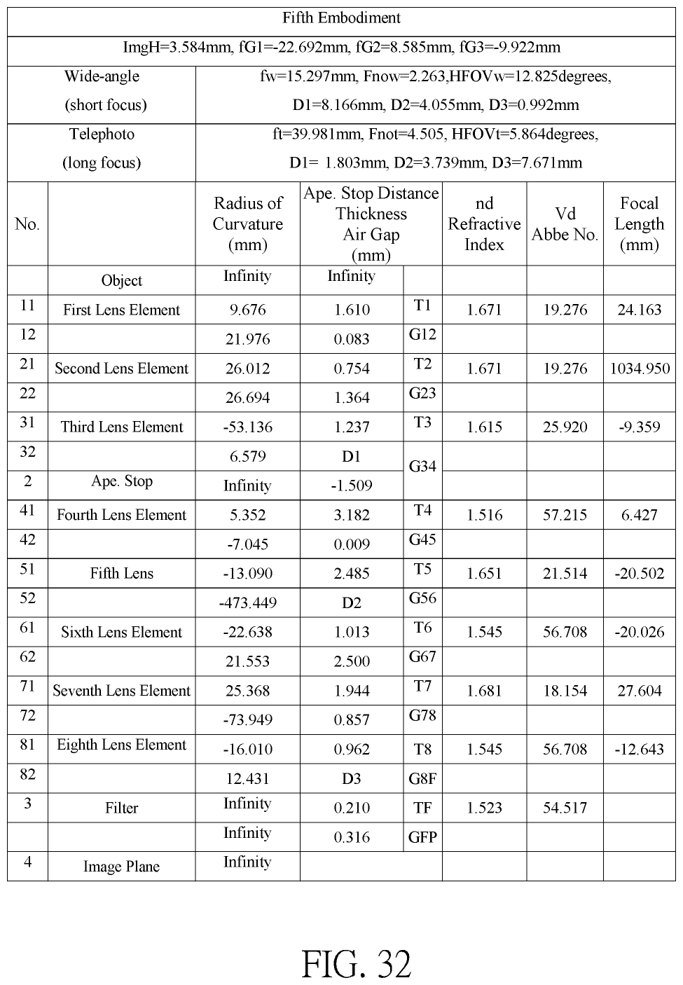

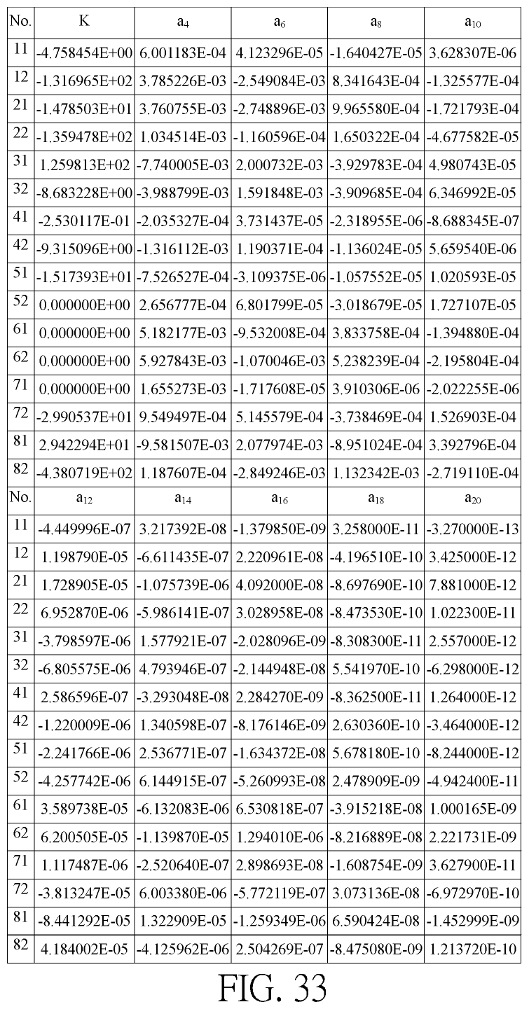

The optical data of the fifth embodiment are shown in FIG. 32, and the aspheric surface data are shown in FIG. 33. In this embodiment, ImgH=3.584 mm, fG1=−22.692 mm, fG2=8.585 mm, fG3=−9.922 mm. When the zoom lens 1 is in the wide-angle (short-focus) state, fw=15.297 mm, Fnow=2.263, HFOVw=12.825 degrees, D1=8.166 mm, D2=4.055 mm, D3=0.992 mm. When the zoom lens 1 is in the telephoto (long-focus) state, ft=39.981 mm, Fnot=4.505, HFOVt=5.864 degrees. D1=1.803 mm, D2=3.739 mm, D3=7.671 mm.

In addition, this embodiment has the following advantages compared with the first embodiment: 1. The longitudinal spherical aberration in the wide-angle state of this embodiment is better than the longitudinal spherical aberration in the wide-angle state of the first embodiment; 2. The field curvature aberration on the sagittal direction in the wide-angle state of this embodiment is better than the field curvature aberration on the sagittal direction in the wide-angle state of the first embodiment; 3. The field curvature aberration on the tangential direction in the wide-angle state of this embodiment is better than the field curvature aberration on the tangential direction in the wide-angle state of the first embodiment; 4. The distortion aberration in the wide-angle state of this embodiment is better than the distortion aberration in the wide-angle state of the first embodiment; 5. The half field of view in the wide-angle state of this embodiment is larger than the half field of view in the wide-angle state of the first embodiment; 6. The distortion aberration in the telephoto state of this embodiment is better than the distortion aberration in the telephoto state of the first embodiment.

### Sixth Embodiment

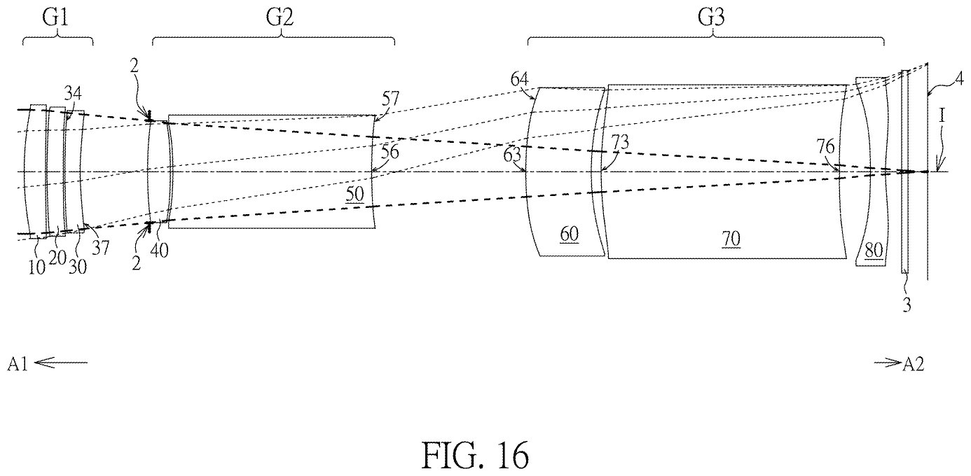

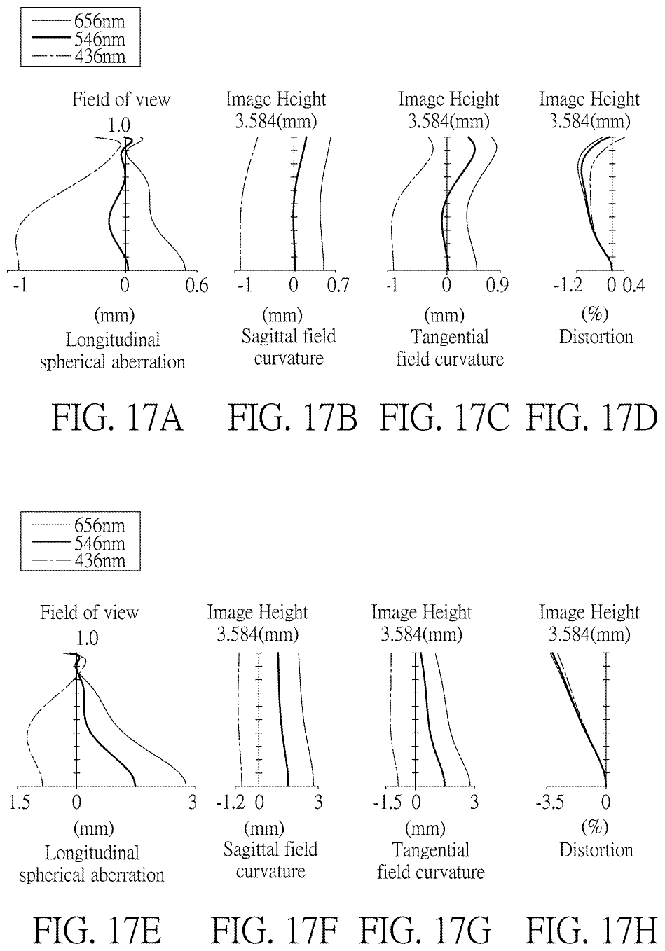

Please refer to FIG. 16 which illustrates the sixth embodiment of the zoom lens 1 of the present invention. Please refer to FIGS. 17A-17H, FIG. 17A illustrates the longitudinal spherical aberration on the image plane in the telephoto state of the sixth embodiment, FIG. 17B illustrates the field curvature aberration on the sagittal direction in the telephoto state of the sixth embodiment, FIG. 17C illustrates the field curvature aberration on the tangential direction in the telephoto state of the sixth embodiment, FIG. 17D illustrates the distortion in the telephoto state of the sixth embodiment, FIG. 17E illustrates the longitudinal spherical aberration on the image plane in the wide-angle state of the sixth embodiment, FIG. 17F illustrates the field curvature aberration on the sagittal direction in the wide-angle state of the sixth embodiment, FIG. 17G illustrates the field curvature aberration on the tangential direction in the wide-angle state of the sixth embodiment, FIG. 17H illustrates the distortion in the wide-angle state of the sixth embodiment. The components in this embodiment are similar to those in the first embodiment, but the optical data such as the lens element refracting power, the radius of curvature, the lens element thickness, the aspheric surface or the back focal length in this embodiment are different from the optical data in the first embodiment. In addition, in this embodiment, the second lens group G2 has negative refracting power, the periphery region 34 of the object-side surface 31 of the third lens element 30 is convex, the periphery region 37 of the image-side surface 32 of the third lens element 30 is concave, the optical axis region 56 of the image-side surface 52 of the fifth lens element 50 is concave, the periphery region 57 of the image-side surface 52 of the fifth lens element 50 is concave, the optical axis region 63 of the object-side surface 61 of the sixth lens element 60 is convex, the periphery region 64 of the object-side surface 61 of the sixth lens element 60 is convex, and the optical axis region 73 of the object-side surface 71 of the seventh lens element 70 is convex, the optical axis region 76 of the image-side surface 72 of the seventh lens element 70 is concave.

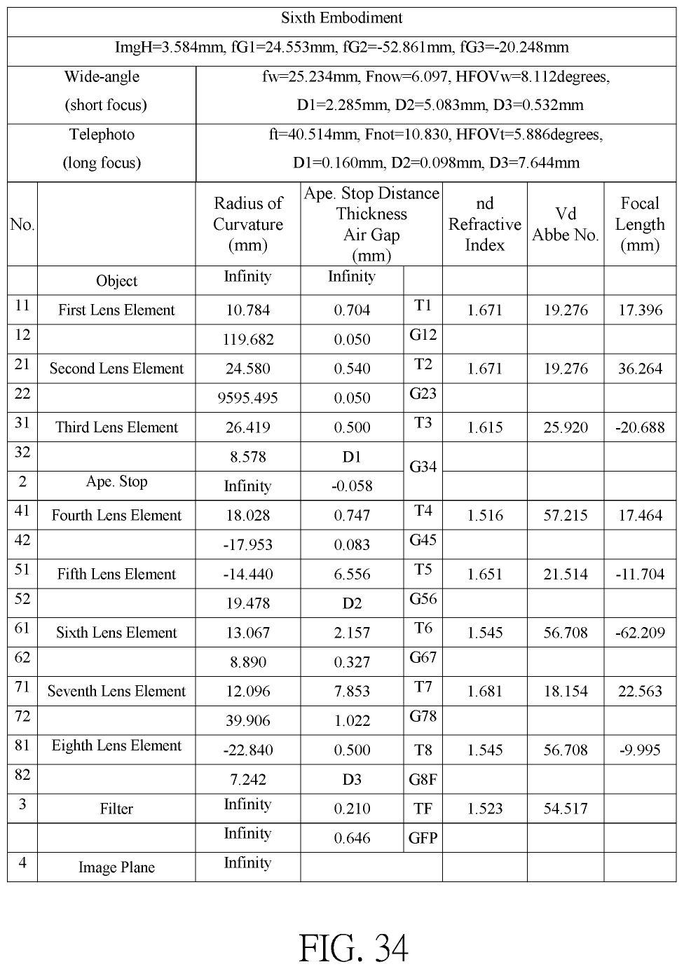

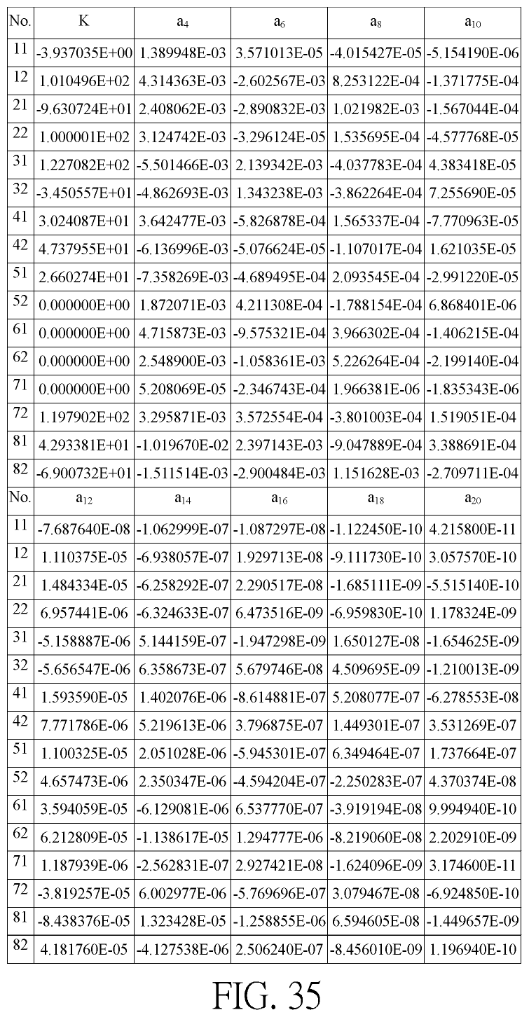

The optical data of the sixth embodiment are shown in FIG. 34, and the aspheric surface data are shown in FIG. 35. In this embodiment, ImgH=3.584 mm, fG1=24.553 mm, fG2=−52.861 mm, fG3=−20.248 mm. When the zoom lens 1 is in the wide-angle (short-focus) state, fw=25.234 mm, Fnow=6.097, HFOVw=8.112 degrees, D1=2.285 mm, D2=5.083 mm and D3=0.532 mm. When the zoom lens 1 is in the telephoto (long-focus) state, ft=40.514 mm, Fnot=10.830, FOVT=5.886 degrees, D1=0.160 mm, D2=0.098 mm, D3=7.644 mm.

In addition, compared with the first embodiment, this embodiment has the following advantages: 1. The distortion aberration in the wide-angle state of this embodiment is better than the distortion aberration of the first embodiment; 2. The distortion aberration in the telephoto state of this embodiment is better than the distortion aberration in the telephoto state of the first embodiment.

### Seventh Embodiment

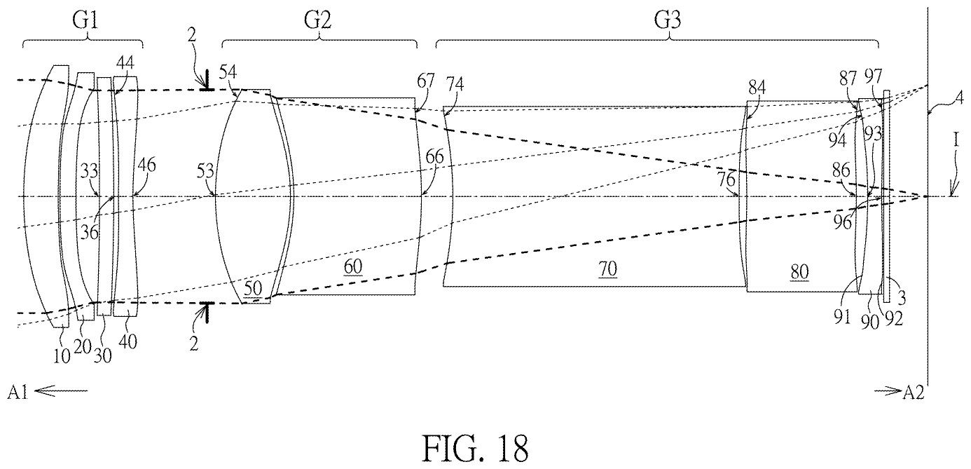

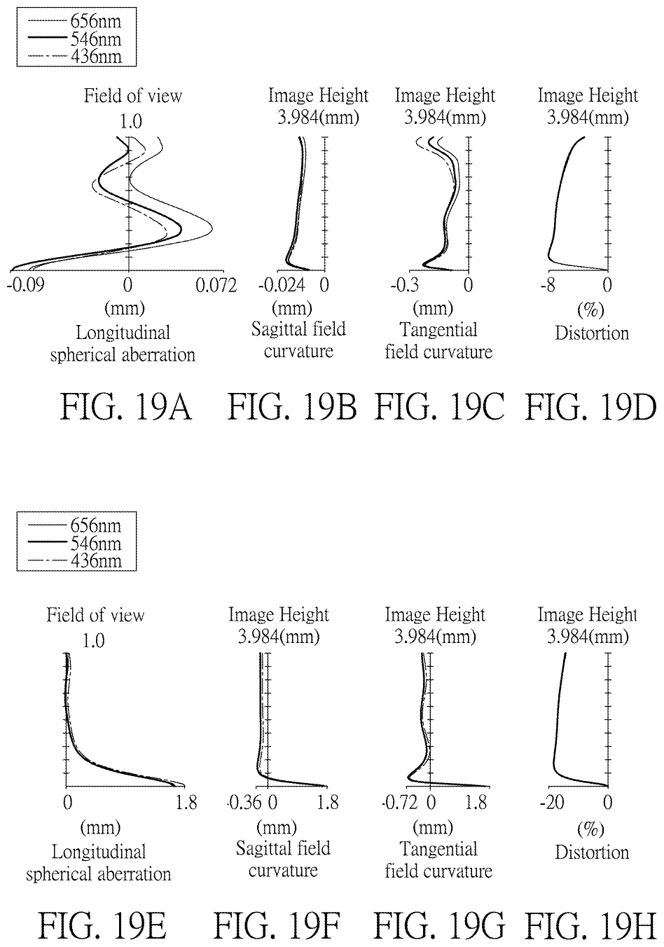

Please refer to FIG. 18 which illustrates the seventh embodiment of the zoom lens 1 of the present invention. Please refer to FIGS. 19A-19H, FIG. 19A illustrates the longitudinal spherical aberration on the image plane in the telephoto state of the seventh embodiment, FIG. 19B illustrates the field curvature aberration on the sagittal direction in the telephoto state of the seventh embodiment, FIG. 19C illustrates the field curvature aberration on the tangential direction in the telephoto state of the seventh embodiment, FIG. 19D illustrates the distortion in the telephoto state of the seventh embodiment, FIG. 19E illustrates the longitudinal spherical aberration on the image plane in the wide-angle state of the seventh embodiment, FIG. 19F illustrates the field curvature aberration on the sagittal direction in the wide-angle state of the seventh embodiment, FIG. 19G illustrates the field curvature aberration on the tangential direction in the wide-angle state of the seventh embodiment, FIG. 19H illustrates the distortion in the wide-angle state of the seventh embodiment. The components in this embodiment are similar to those in the first embodiment, but the optical data such as the lens element refracting power, the radius of curvature, the lens element thickness, the aspheric surface or the back focal length in this embodiment are different from the optical data in the first embodiment. In addition, in this embodiment, the third lens element 30 has positive refracting power, the optical axis region 33 of the object-side surface 31 of the third lens element 30 is concave, the optical axis region 36 of the image-side surface 32 of the third lens element 30 is convex, the fourth lens element 40 has negative refracting power, the periphery region 44 of the object-side surface 41 of the fourth lens element 40 is concave, the optical axis region 46 of the image-side surface 42 of the fourth lens element 40 is concave, and the fifth lens element 50 has positive refracting power. The optical axis region 53 of the object-side surface 51 of the fifth lens element 50 is convex, the periphery region 54 of the object-side surface 51 of the fifth lens element 50 is convex, the optical axis region 66 of the image-side surface 62 of the sixth lens element 60 is convex, the periphery region 67 of the image-side surface 62 of the sixth lens element 60 is convex, the seventh lens element 70 has negative refracting power, the periphery region 74 of the object-side surface 71 of the seventh lens element 70 is concave, the optical axis region 76 of the image-side surface 72 of the seventh lens element 70 is concave, and the eighth lens element 80 has positive refracting power, the periphery region 84 of the object-side surface 81 of the eighth lens element 80 is convex, the optical axis region 86 of the image-side surface 82 of the eighth lens element 80 is convex, and the periphery region 87 of the image-side surface 82 of the eighth lens element 80 is concave.

In addition, this embodiment also includes a ninth lens element 90, which is located between the eighth lens element 80 and the filter 3. In this embodiment, the first lens group G1 includes the first lens element 10, the second lens element 20, the third lens element 30 and the fourth lens element 40, the second lens group G2 includes the fifth lens element 50 and the sixth lens element 60, and the third lens group G3 includes the seventh lens element 70, the eighth lens element 80 and the ninth lens element 90. In addition, the aperture stop 2 in this embodiment is located between the fourth lens element 40 and the fifth lens element 50.

The ninth lens element 90 has negative refracting power, the optical axis region 93 of the object-side surface 91 of the ninth lens element 90 is concave, the periphery region 94 of the object-side surface 91 of the ninth lens element 90 is concave, the optical axis region 96 of the image-side surface 92 of the ninth lens element 90 is concave, the periphery region 97 of the image-side surface 92 of the ninth lens element 90 is convex. Both the object-side surface 91 and the image-side surface 92 of the ninth lens element 90 are aspheric surfaces, but it is not limited thereto.

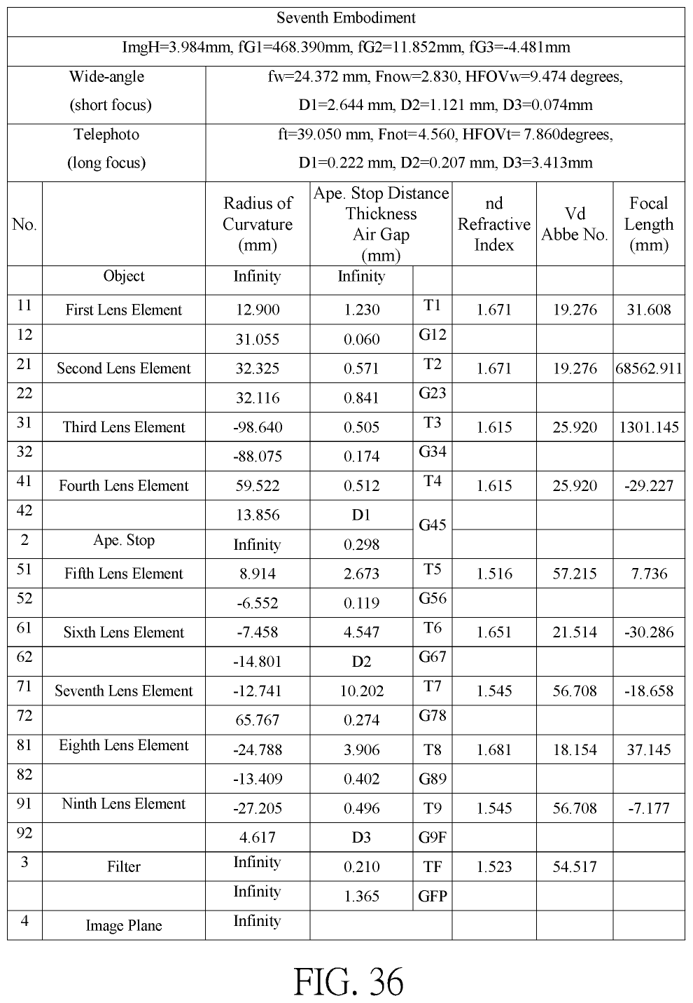

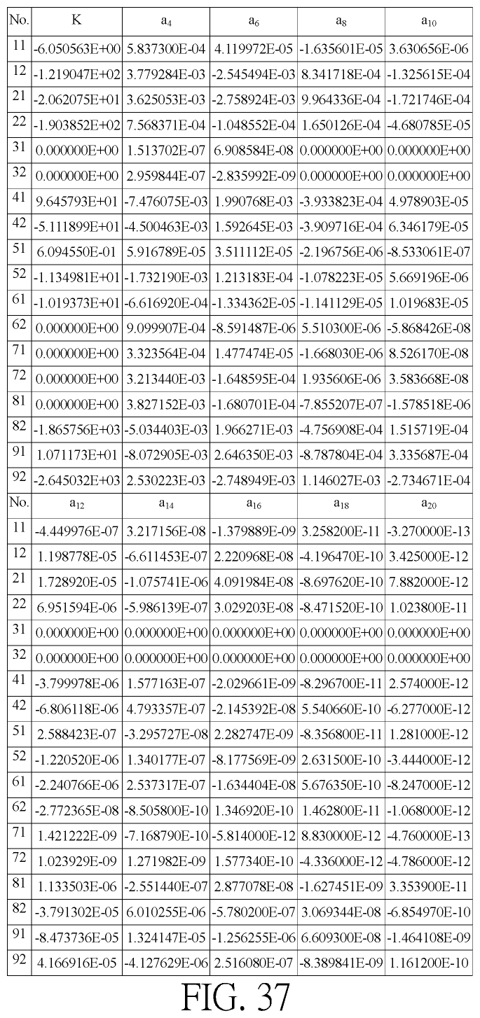

The optical data of the seventh embodiment are shown in FIG. 36, and the aspheric data are shown in FIG. 37. In this embodiment, ImgH=3.984 mm, fG1=468.390 mm, fG2=11.852 mm, fG3=−4.481 mm. When the zoom lens 1 is in the wide-angle (short-focus) state, fw=24.372 mm, Fnow=2.830, HFOVw=9.474 degrees, D1=2.644 mm, D2=1.121 mm, D3=0.074 mm. When the zoom lens 1 is in the telephoto (long-focus) state, ft=39.050 mm, Fnot=4.560, HFOVt=7.860 degrees, D1=0.222 mm, D2=0.207 mm, D3=3.413 mm.

In addition, this embodiment has the following advantages compared with the first embodiment: 1. The longitudinal spherical aberration in the wide-angle state of this embodiment is better than the longitudinal spherical aberration in the wide-angle state of the first embodiment; 2. The field curvature aberration on the sagittal direction in the wide-angle state of this embodiment is better than the field curvature aberration on the sagittal direction in the wide-angle state of the first embodiment; 3. The field curvature aberration on the tangential direction in the wide-angle state of this embodiment is better than the field curvature aberration on the tangential direction in the wide-angle state of the first embodiment; 4. The distortion aberration in the wide-angle state of this embodiment is better than the distortion aberration in the wide-angle state of the first embodiment; 5. The distortion aberration in the telephoto state of this embodiment is better than the distortion aberration in the telephoto state of the first embodiment.

### Eighth Embodiment

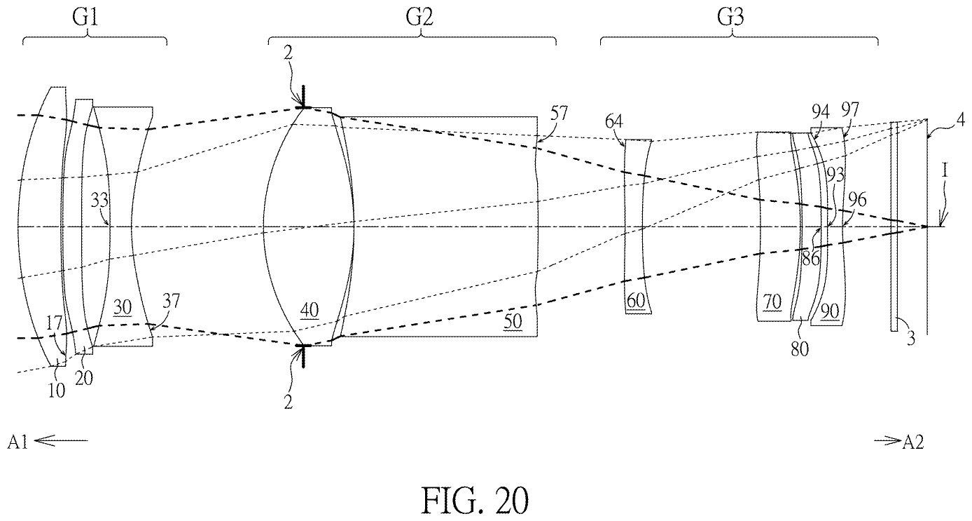

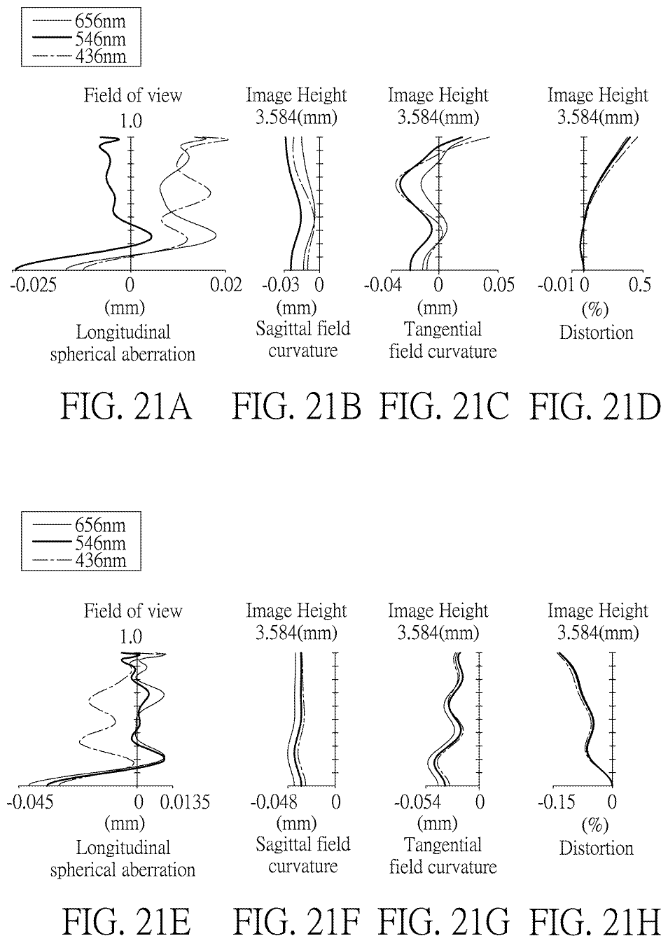

Please refer to FIG. 20 which illustrates the eighth embodiment of the zoom lens 1 of the present invention. Please refer to FIGS. 21A-21H, FIG. 21A illustrates the longitudinal spherical aberration on the image plane in the telephoto state of the eighth embodiment, FIG. 21B illustrates the field curvature aberration on the sagittal direction in the telephoto state of the eighth embodiment, FIG. 21C illustrates the field curvature aberration on the tangential direction in the telephoto state of the eighth embodiment, FIG. 21D illustrates the distortion in the telephoto state of the eighth embodiment, FIG. 21E illustrates the longitudinal spherical aberration on the image plane in the wide-angle state of the eighth embodiment, FIG. 21F illustrates the field curvature aberration on the sagittal direction in the wide-angle state of the eighth embodiment, FIG. 21G illustrates the field curvature aberration on the tangential direction in the wide-angle state of the eighth embodiment, FIG. 21H illustrates the distortion in the wide-angle state of the eighth embodiment. The components in this embodiment are similar to those in the first embodiment, but the optical data such as the lens element refracting power, the radius of curvature, the lens element thickness, the aspheric surface or the back focal length in this embodiment are different from the optical data in the first embodiment. In addition, in this embodiment, the first lens group G1 has negative refracting power, the periphery region 17 of the image-side surface 12 of the first lens element 10 is convex, the optical axis region 33 of the object-side surface 31 of the third lens element 30 is concave, the periphery region 37 of the image-side surface 32 of the third lens element 30 is concave, the periphery region 57 of the image-side surface 52 of the fifth lens element 50 is concave, the periphery region 64 of the object-side surface 61 of the sixth lens element 60 is convex, and the optical axis region 86 of the image-side surface 82 of the eighth lens element 80 is convex.

In addition, this embodiment also includes a ninth lens element 90 located between the eighth lens element 80 and the filter 3. In this embodiment, the first lens group G1 includes the first lens element 10, the second lens element 20 and the third lens element 30, the second lens group G2 includes the fourth lens element 40, the fifth lens element 50 and the sixth lens element 60, and the third lens group G3 includes the seventh lens element 70, the eighth lens element 80 and the ninth lens element 90.

The ninth lens element 90 has negative refracting power, the optical axis region 93 of the object-side surface 91 of the ninth lens element 90 is convex, the periphery region 94 of the object-side surface 91 of the ninth lens element 90 is concave, and the optical axis region 96 of the image-side surface 92 of the ninth lens element 90 is concave, the periphery region 97 of the image-side surface 92 of the ninth lens element 90 is convex. Both the object-side surface 91 and the image-side surface 92 of the ninth lens element 90 are aspheric surfaces, but it is not limited thereto.

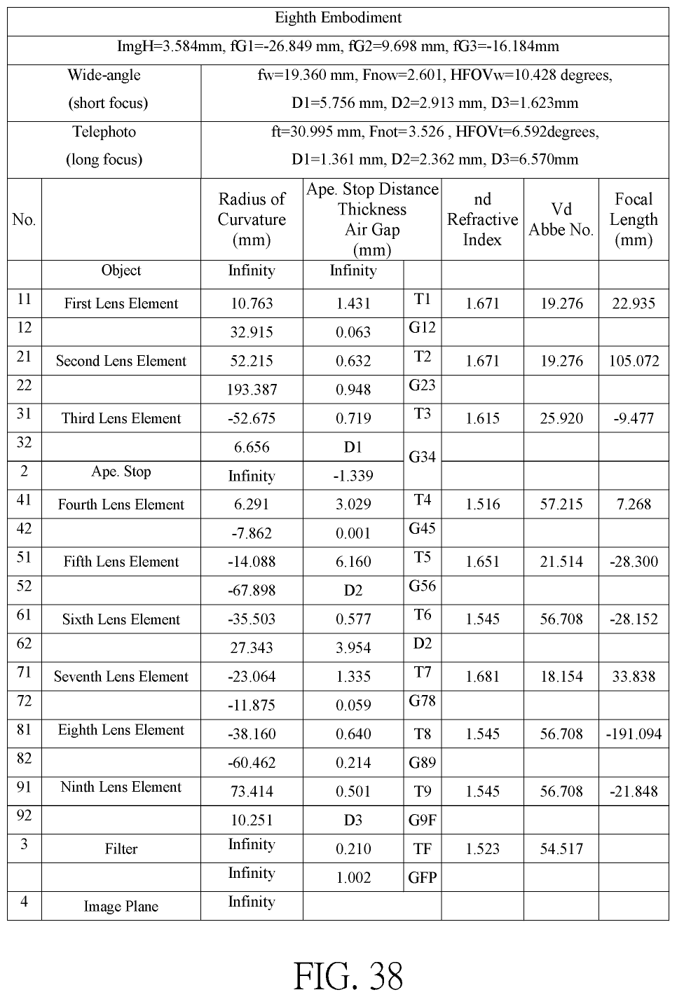

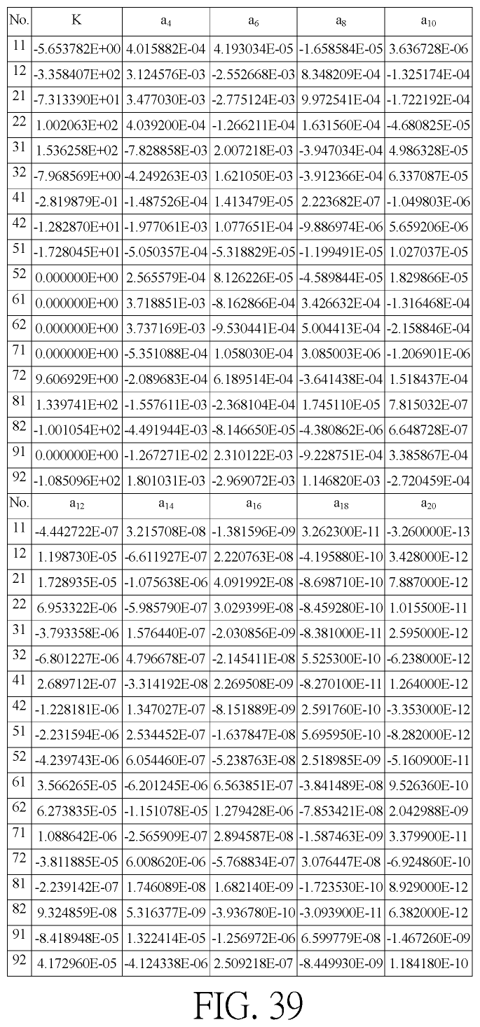

The optical data of the eighth embodiment are shown in FIG. 38, and the aspheric surface data are shown in FIG. 39. In this embodiment, ImgH=3.584 mm, fG1=−26.849 mm, fG2=9.698 mm, fG3=−16.184 mm. When the zoom lens 1 is in the wide-angle (short-focus) state, fw=19.360 mm, Fnow=2.601, HFOVw=10.428 degrees, D1=5.756 mm, D2=2.913 mm, D3=1.623 mm. When the zoom lens 1 is in the telephoto (long-focus) state, ft=30.995 mm, Fnot=3.526, HFOVt=6.592 degrees. D1=1.361 mm, D2=2.362 mm, D3=6.570 mm.

In addition, this embodiment has the following advantages compared with the first embodiment: 1. The longitudinal spherical aberration in the wide-angle state of this embodiment is better than the longitudinal spherical aberration in the wide-angle state of the first embodiment; 2. The field curvature aberration on the sagittal direction in the wide-angle state of this embodiment is better than the field curvature aberration on the sagittal direction in the wide-angle state of the first embodiment; 3. The field curvature aberration on the tangential direction in the wide-angle state of this embodiment is better than the field curvature aberration on the tangential direction in the wide-angle state of the first embodiment; 4. The distortion aberration in the wide-angle state of this embodiment is better than the distortion aberration in the wide-angle state of the first embodiment; 5. The half field of view in the wide-angle state of this embodiment is larger than the half field of view in the wide-angle state of the first embodiment; 6. The longitudinal spherical aberration in the telephoto state of this embodiment is better than the longitudinal spherical aberration in the telephoto state of the first embodiment; 7. The field curvature aberration on the sagittal direction in the telephoto state of this embodiment is better than the field curvature aberration on the sagittal direction in the telephoto state of the first embodiment; 8. The field curvature aberration on the tangential direction in the telephoto state of this embodiment is better than the field curvature aberration on the tangential direction in the telephoto state of the first embodiment; 9. The distortion aberration in the telephoto state of this embodiment is better than the distortion aberration in the telephoto state of the first embodiment.

### Ninth Embodiment

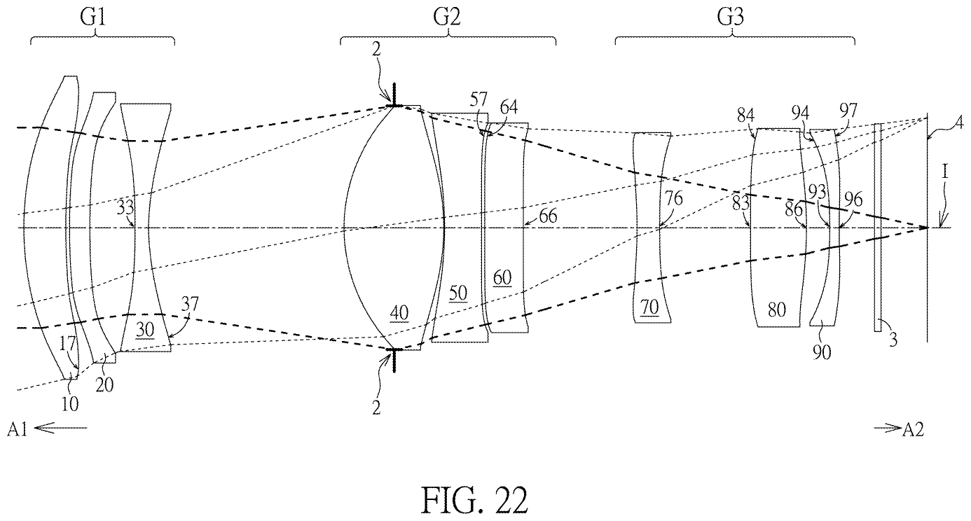

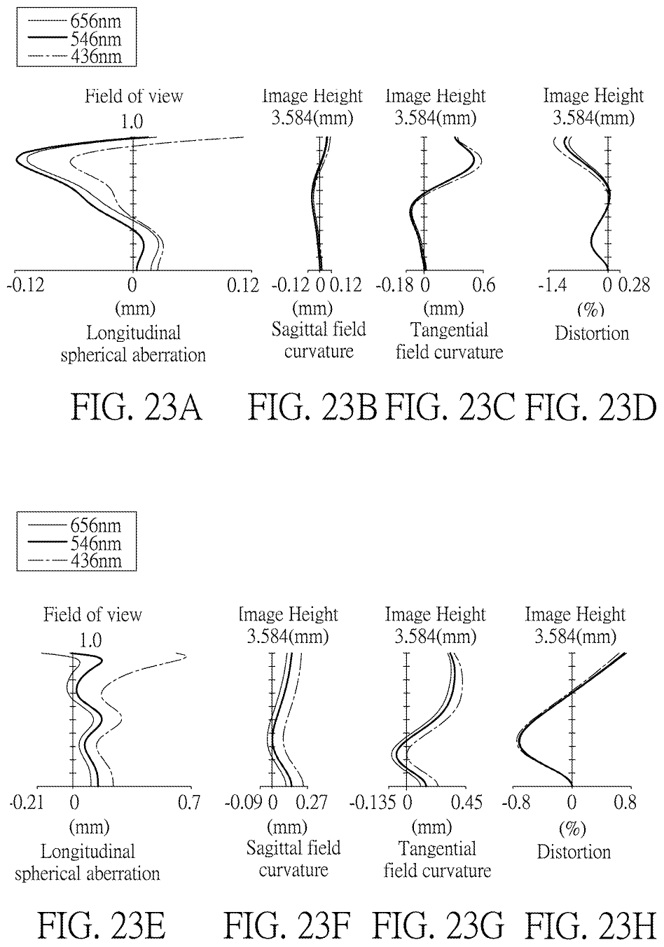

Please refer to FIG. 22 which illustrates the ninth embodiment of the zoom lens 1 of the present invention. Please refer to FIGS. 23A-23H, FIG. 23A illustrates the longitudinal spherical aberration on the image plane in the telephoto state of the ninth embodiment, FIG. 23B illustrates the field curvature aberration on the sagittal direction in the telephoto state of the ninth embodiment, FIG. 23C illustrates the field curvature aberration on the tangential direction in the telephoto state of the ninth embodiment, FIG. 23D illustrates the distortion in the telephoto state of the ninth embodiment, FIG. 23E illustrates the longitudinal spherical aberration on the image plane in the wide-angle state of the ninth embodiment, FIG. 23F illustrates the field curvature aberration on the sagittal direction in the wide-angle state of the ninth embodiment, FIG. 23G illustrates the field curvature aberration on the tangential direction in the wide-angle state of the ninth embodiment, FIG. 23H illustrates the distortion in the wide-angle state of the ninth embodiment. The components in this embodiment are similar to those in the first embodiment, but the optical data such as the lens element refracting power, the radius of curvature, the lens element thickness, the aspheric surface or the back focal length in this embodiment are different from the optical data in the first embodiment. In addition, in this embodiment, the first lens group G1 has negative refracting power, the periphery region 17 of the image-side surface 12 of the first lens element 10 is convex, the optical axis region 33 of the object-side surface 31 of the third lens element 30 is concave, the periphery region 37 of the image-side surface 32 of the third lens element 30 is concave, the periphery region 57 of the image-side surface 52 of the fifth lens element 50 is concave, the sixth lens element 60 has positive refracting power, the periphery region 64 of the object-side surface 61 of the sixth lens element 60 is convex, the optical axis region 66 of the image-side surface 62 of the sixth lens element 60 is convex, the seventh lens element 70 has negative refracting power, the optical axis region 76 of the image-side surface 72 of the seventh lens element 70 is concave, the eighth lens element 80 has positive refracting power, the optical axis region 83 of the object-side surface 81 of the eighth lens element 80 is convex, the periphery region 84 of the object-side surface 81 of the eighth lens element 80 is convex, and the optical axis region 86 of the image-side surface 82 of the eighth lens element 80 is convex.

In this embodiment, this embodiment also includes a ninth lens element 90 located between the eighth lens element 80 and the filter 3. The first lens group G1 includes the first lens element 10, the second lens element 20 and the third lens element 30, the second lens group G2 includes the fourth lens element 40 and the fifth lens element 50, and the third lens group G3 includes the sixth lens element 60, the seventh lens element 70, the eighth lens element 80 and the ninth lens element 90.

The ninth lens element 90 has negative refracting power, the optical axis region 93 of the object-side surface 91 of the ninth lens element 90 is concave, the periphery region 94 of the object-side surface 91 of the ninth lens element 90 is concave, the optical axis region 96 of the image-side surface 92 of the ninth lens element 90 is concave, the periphery region 97 of the image-side surface 92 of the ninth lens element 90 is convex. Both the object-side surface 91 and the image-side surface 92 of the ninth lens element 90 are aspheric surfaces, but it is not limited thereto.

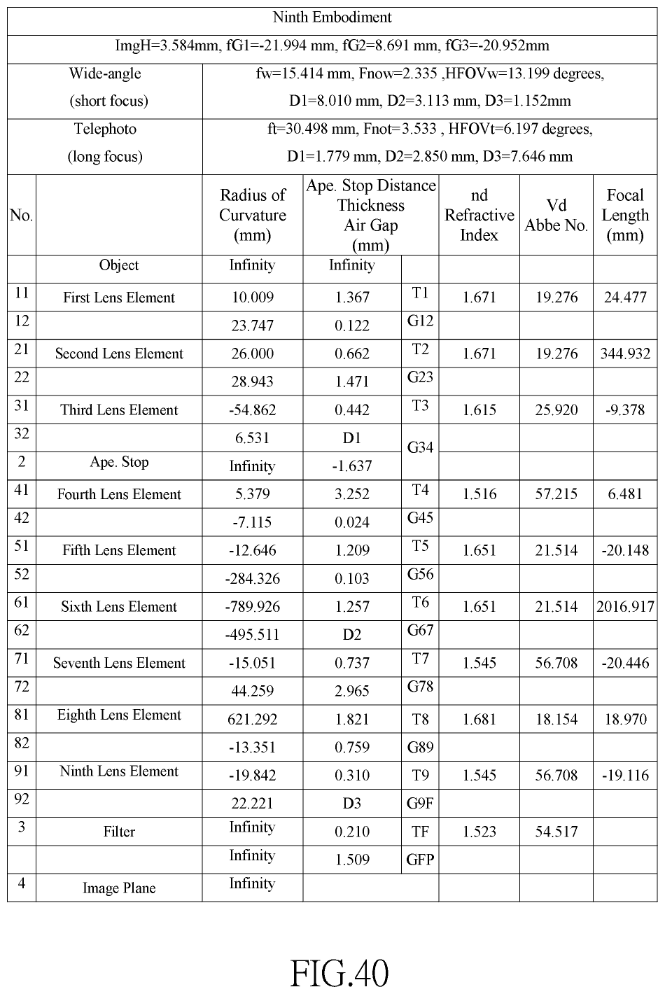

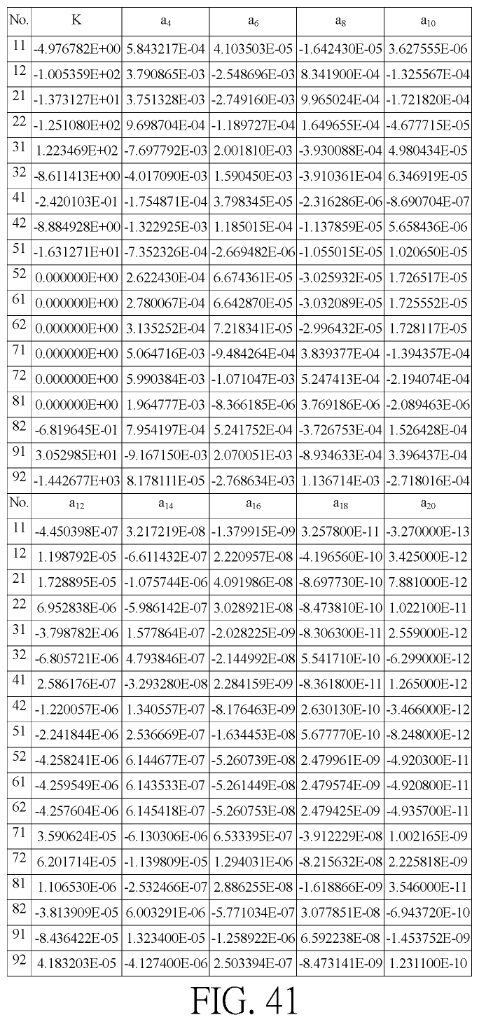

The optical data of the ninth embodiment are shown in FIG. 40, and the aspheric surface data are shown in FIG. 41. In this embodiment, ImgH=3.584 mm, fG1=−21.994 mm, fG2=8.691 mm, fG3=−20.952 mm. When the zoom lens 1 is in the wide-angle (short-focus) state, fw=15.414 mm, Fnow=2.335, HFOVw=13.199 degrees, D1=8.010 mm, D2=3.113 mm and D3=1.152 mm. When the zoom lens 1 is in the telephoto (long-focus) state, ft=30.498 mm, Fnot=3.533, HFOVt=6.197 degrees, D1=1.779 mm, D2=2.850 mm, D3=7.646 mm.

In addition, this embodiment has the following advantages compared with the first embodiment: 1. The longitudinal spherical aberration in the wide-angle state of this embodiment is better than the longitudinal spherical aberration in the wide-angle state of the first embodiment; 2. The field curvature aberration on the sagittal direction in the wide-angle state of this embodiment is better than the field curvature aberration on the sagittal direction in the wide-angle state of the first embodiment; 3. The field curvature aberration on the tangential direction in the wide-angle state of this embodiment is better than the field curvature aberration on the tangential direction in the wide-angle state of the first embodiment; 4. The distortion aberration in the wide-angle state of this embodiment is better than the distortion aberration in the wide-angle state of the first embodiment; 5. The half field of view in the wide-angle state of this embodiment is larger than the half field of view in the wide-angle state of the first embodiment; 6. The longitudinal spherical aberration in the telephoto state of this embodiment is better than the longitudinal spherical aberration in the telephoto state of the first embodiment; 7. The field curvature aberration on the sagittal direction in the telephoto state of this embodiment is better than the field curvature aberration on the sagittal direction in the telephoto state of the first embodiment; 8. The field curvature aberration on the tangential direction in the telephoto state of this embodiment is better than the field curvature aberration on the tangential direction in the telephoto state of the first embodiment; 9. The distortion aberration in the telephoto state of this embodiment is better than the distortion aberration in the telephoto state of the first embodiment.

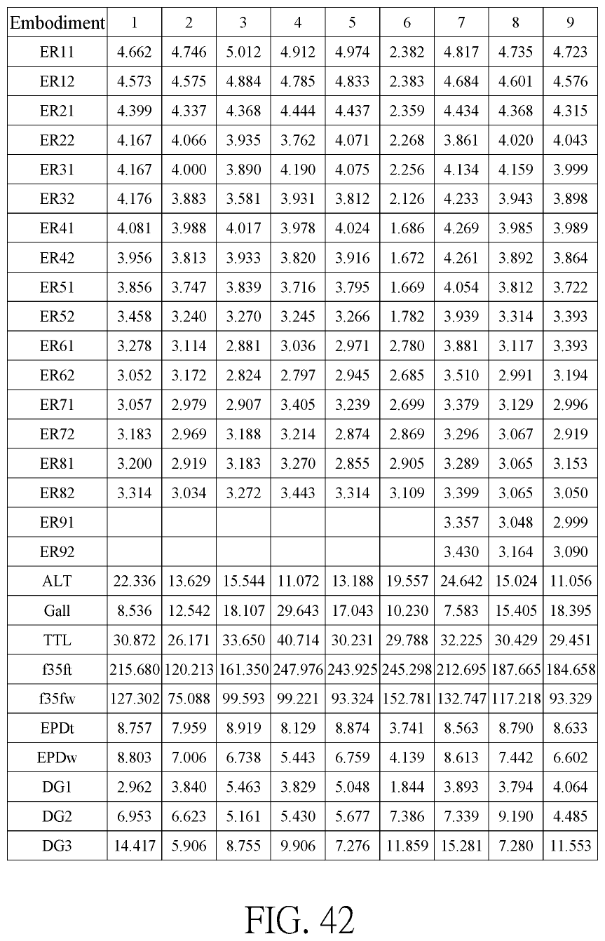

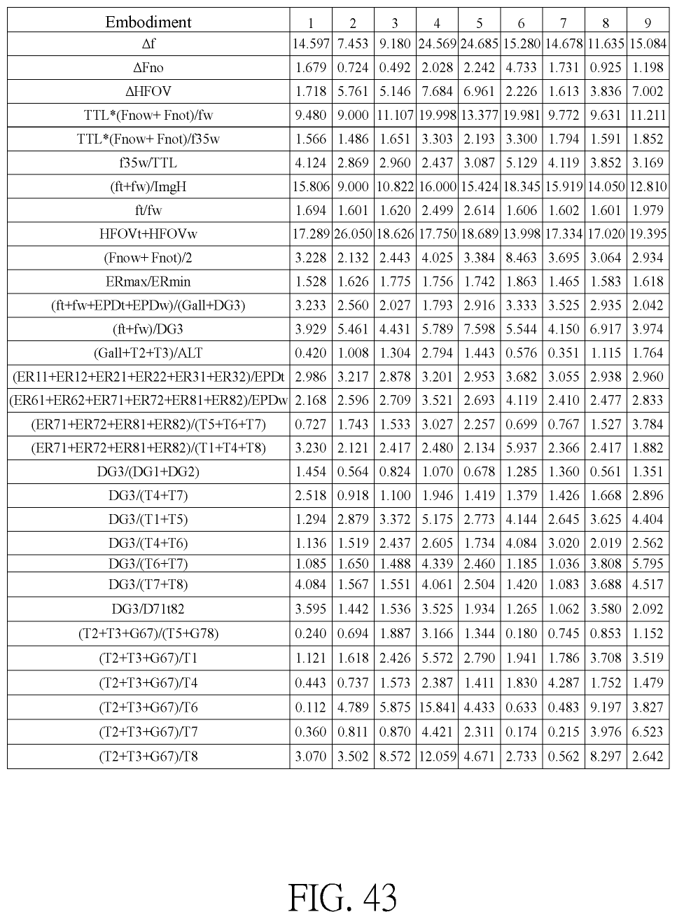

In addition, the important ratios in the wide-angle state or the telephoto state of each embodiment are shown in FIG. 42 and FIG. 43 respectively.

Embodiments of the present invention provide a zoom lens, which has the following corresponding effects:

1. The zoom lens of the present invention has only three lens groups. If more than three lens groups are designed, it is not conducive to reducing the volume of the zoom lens and its zoom device, and if less than three lens groups are designed, it is not conducive to increasing the zoom magnification of the zoom lens. The more the zoom lens with three lens groups meets the following characteristics, the more favorable it is to design a zoom lens that can be installed in portable electronic products, and correct the aberration when the air gap changes during zooming: the second lens group has positive refracting power;
the third lens group has negative refracting power;
the first lens element has positive refracting power;
the lens element closest to the image side has negative refracting power;
the periphery region of the image-side surface of the lens element closest to the image side is convex.

2. The zoom lens of the present invention satisfies the relationship of f35w/TTL≥2.200, which is beneficial to zoom the zoom lens within a limited system length, and at the same time, the effective focal length of the 35 mm equivalent focal length format of the zoom lens in the wide-angle state is increased, and the preferable range is 2.200≥f35w/TTL≥5.200.

3. In order to make the telephoto performance better, the zoom lens of the present invention satisfies the relationships of TTL*(Fnow+Fnot)/fw≤20.000 or TTL*(Fnow+Fnot)/f35w≤3.400, which is beneficial for the zoom lens to zoom in a limited system length, and at the same time, it limits the f-numbers in the wide-angle state and the telephoto state, which is beneficial to absorb more imaging rays to improve the relative illumination of the image. The preferable range of relationship is 9.000≤TTL*(Fnow+Fnot)/fw≤20.000 or 1.400≤TTL*(Fnow+Fnot)/f35w≤3.400.

4. The zoom lens of the present invention satisfies the relationship of (Fnow+Fnot)/2≤4.100, which is beneficial to absorb more imaging rays to improve the relative illumination of the image, the preferable range of relationship is 2.000≤(Fnow+Fnot)/234.100.

5. The zoom lens of the present invention satisfies the relationship of 2.800≤f35w/26.2, which is beneficial to improve the zoom magnification of the zoom lens relative to f35=26 mm in the wide-angle state, and the preferable range of relationship is 2.800≤f35w/26.236.000.

6. The zoom lens of the present invention satisfies the relationship of 4.500≤f35t/26.2, which is beneficial to improve the zoom magnification of the zoom lens relative to f35-26 mm in the telephoto state, and the preferable range of relationship is 4.500≤f35t/26.2≤10.000.

7. The zoom lens of the present invention satisfies the relationship of 9.000≤(ft+fw)/ImgH or HFOVt+HFOVw≤27.000 degrees, which is beneficial to improve the zoom magnification of the zoom lens in the wide-angle state and the telephoto state at the same time, and the preferable range of relationship is 9.000≤(ft+fw)/ImgH≤20.000 or 13.000 degrees≤HFOVt+HFOVw≤27.000 degrees.

8. The zoom lens of the present invention satisfies the relationships of 1.600≤ ft/fw, 7.000 mm≤Δf, 0.400≤ΔFno or 1.500 degrees≤ΔHFOV, which is beneficial to improving the zoom magnification of the zoom lens in the wide-angle state and the telephoto state, and the preferable range of relationship is 1.600≤ft/fw≤2.800, 7.000 mm≤Δf≤25.000 mm, 0.400≤ΔFno≤4.800 or 1.500 degrees≤ΔHFOV≤8.000 degrees.

9. The zoom lens of the present invention further satisfies the Abbe number of the second lens element whose Abbe number is more than 2 times of the lens element closest to the image side, or the Abbe number of the third lens element whose Abbe number is more than 2 times of the lens element closest to the image side, which is beneficial to correcting the chromatic aberration and distortion of the zoom lens.

10. The zoom lens of the present invention further satisfies the relationships of 3.800≤(ft+fw)/DG3 or 1.790≤(ft+fw+EPDt+EPDw)/(Gall+DG3), which is beneficial to increase the zoom magnification of the zoom lens while maintaining a certain length of the third lens group, with a preferable range of 3.800≤(ft+fw)/DG3≤7.600 or

1.790≤(ft+fw+EPDt+EPDw)/(Gall+DG3)≤3.800.

11. the zoom lens of the present invention further satisfies the relationships of
(ER11+ER12+ER21+ER22+ER31+ER32)/EPDt≤3.700 or
(ER61+ER62+ER71+ER72+ER81+ER82)/EPDw≤4.200, which is beneficial to increase the entrance pupil diameter of the zoom lens and give the zoom lens enough imaging rays at the same time to increase the zoom magnification of the zoom lens. The preferable range is

$$2.6 \leq ( ER 11 + ER 12 + ER 21 + ER 22 + ER 31 + ER 32 ) / EPDt \leq 3.7 or 2.1 \leq ( ER 61 + ER 62 + ER 71 + ER 72 + ER 81 + E R82 ) / EPDw \leq 4.2 .$$

12. The zoom lens of the present invention has only eight lens elements, which is beneficial to reducing the volume of the zoom lens. Or the zoom lens of the invention has only nine lens elements, which is beneficial to designing more lens elements to correct aberrations such as distortion.

13. For the relationships listed in Table 1 below, at least one of them aims to keep the effective radius, thickness and air gaps of each lens element at an appropriate value, so as to avoid that any parameter is too large to be detrimental to the miniaturization of the zoom lens as a whole, or that any parameter is too small to affect the assembly or improve the manufacturing difficulty.

TABLE 1

| Relationships | Preferable range |
|---|---|
| (Gall + T2 + T3)/ALT ≥ 0.250 | 0.250 ≤ (Gall + T2 + T3)/ALT ≤ |
| | 2.800 |
| (ER71 + ER72 + ER81 + | 0.600 ≤ (ER71 + ER72 + ER81 + |
| ER82)/(T5 + T6 + T7) ≥ 0.600 | ER82)/(T5 + T6 + T7) ≤ 3.800 |
| (ER71 + ER72 + ER81 + | 1.800 ≤ (ER71 + ER72 + ER81 + |
| ER82)/T1 + T4 + T8) ≥ 1.800 | ER82)/(T1 + T4 + T8) ≤ 6.000 |
| DG3/(DG1 + DG2) ≥ 0.500 | 0.500 ≤ DG3/(DG1 + DG2) ≤ 1.500 |
| DG3/(T4 + T7) ≥ 0.900 | 0.900 ≤ DG3/(T4 + T7) ≤ 3.000 |
| DG3/(T1 + T5) ≥ 1.200 | 1.200 ≤ DG3/(T1 + T5) ≤ 5.200 |
| DG3/(T4 + T6) ≥ 1.000 | 1.000 ≤ DG3/(T4 + T6) ≤ 4.100 |
| DG3/(T6 + T7) ≥ 1.000 | 1.000 ≤ DG3/(T6 + T7) ≤ 6.000 |
| DG3/(T7 + T8) ≥ 1.000 | 1.000 ≤ DG3/(T7 + T8) ≤ 4.600 |
| DG3/D71t82 ≥ 1.000 | 1.000 ≤ DG3/D71t82 ≤ 3.600 |
| (T2 + T3 + G67)/(T5 + | 0.100 ≤ (T2 + T3 + G67)/(T5 + |
| G78) ≥ 0.100 | G78) ≤ 3.200 |
| (T2 + T3 + G67)/T1 ≥ 1.000 | 1.000 ≤ (T2 + T3 + G67)/T1 ≤ 5.600 |
| (T2 + T3 + G67)/T4 ≥ 0.400 | 0.400 ≤ (T2 + T3 + G67)/T4 ≤ 4.300 |
| (T2 + T3 + G67)/T6 ≥ 0.100 | 0.100 ≤ (T2 + T3 + G67)/T6 ≤ 15.900 |
| (T2 + T3 + G67)/T7 ≥ 0.100 | 0.100 ≤ (T2 + T3 + G67)/T7 ≤ 6.600 |
| (T2 + T3 + G67)/T8 ≥ 0.300 | 0.300 ≤ (T2 + T3 + G67)/T8 ≤ 12.100 |

In addition, any arbitrary combination of the parameters of the embodiments can be selected to increase the lens limitation so as to facilitate the design of the same structure of the present invention.

In the light of the unpredictability of the optical imaging lens, the present invention suggests the above principles to have a shorter system length of the optical imaging lens, lower f-number, larger image height and better imaging quality or a better fabrication yield to overcome the drawbacks of prior art. And by use of plastic material for the lens element of the present invention can further reduce the weight and cost of the optical imaging lens.

The numerical range including the maximum and minimum values obtained from the combination proportional relationship of optical parameters disclosed in various embodiments of the present invention can be implemented accordingly.

The contents in the embodiments of the invention include but are not limited to a focal length, a thickness of a lens element, an Abbe number, or other optical parameters. For example, in the embodiments of the invention, an optical parameter A and an optical parameter B are disclosed, wherein the ranges of the optical parameters, comparative relation between the optical parameters, and the range of a conditional expression covered by a plurality of embodiments are specifically explained as follows:

(1) The ranges of the optical parameters are, for example, α₂≤A≤α₁ or β₂≤B≤β₁, where α₁ is a maximum value of the optical parameter A among the plurality of embodiments, α₂ is a minimum value of the optical parameter A among the plurality of embodiments, β₁ is a maximum value of the optical parameter B among the plurality of embodiments, and β₂ is a minimum value of the optical parameter B among the plurality of embodiments.

(2) The comparative relation between the optical parameters is that A is greater than B or A is less than B, for example.

(3) The range of a conditional expression covered by a plurality of embodiments is in detail a combination relation or proportional relation obtained by a possible operation of a plurality of optical parameters in each same embodiment. The relation is defined as E, and E is, for example, A+B or A-B or A/B or A*B or (A*B)^{1/2}, and E satisfies a conditional expression E≤γ₁ or E≥γ₂ or γ₂≤E≤γ₁, where each of γ₁ and γ₂ is a value obtained by an operation of the optical parameter A and the optical parameter B in a same embodiment, γ₁ is a maximum value among the plurality of the embodiments, and γ₂ is a minimum value among the plurality of the embodiments.

The ranges of the aforementioned optical parameters, the aforementioned comparative relations between the optical parameters, and a maximum value, a minimum value, and the numerical range between the maximum value and the minimum value of the aforementioned conditional expressions are all implementable and all belong to the scope disclosed by the invention. The aforementioned description is for exemplary explanation, but the invention is not limited thereto.

The embodiments of the invention are all implementable. In addition, a combination of partial features in a same embodiment can be selected, and the combination of partial features can achieve the unexpected result of the invention with respect to the prior art. The combination of partial features includes but is not limited to the surface shape of a lens element, a refracting power, a conditional expression or the like, or a combination thereof. The description of the embodiments is for explaining the specific embodiments of the principles of the invention, but the invention is not limited thereto. Specifically, the embodiments and the drawings are for exemplifying, but the invention is not limited thereto.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A zoom lens comprising a first lens group, a second lens group and a third lens group in sequence along an optical axis from an object side to an image side, wherein the zoom lens has at least a wide-angle state and a telephoto state;
the second lens group has positive refracting power;
the zoom lens has only the above three lens groups and satisfies the following relationships:
$$TTL * ( Fnow + Fnot ) / fw \leq 20. ; ( ft + fw ) / ImgH \geq 9. ; and ft / fw \geq 1.6 ;$$
wherein TTL is a system length of the zoom lens, Fnow is an f-number of the zoom lens in the wide-angle state, Fnot is an f-number of the zoom lens in the telephoto state, fw is an effective focal length of the zoom lens in the wide-angle state, ft is an effective focal length of the zoom lens in the telephoto state, and ImgH is a maximum image height of the zoom lens.

2. The zoom lens according to claim 1, wherein the zoom lens satisfies the following relationships: (ft+fw+EPDt+EPDw)/(Gall+DG3)≥1.790, wherein EPDt is an entrance pupil diameter of the zoom lens in the telephoto state, EPDw is an entrance pupil diameter of the zoom lens in the wide-angle state, Gall is a sum of the air gaps of all lens elements of the zoom lens along the optical axis plus back focal length, and DG3 is a length of the third lens group along the optical axis.

3. The zoom lens according to claim 1, wherein the zoom lens comprises at least a first lens element, a second lens element, a third lens element, a fourth lens element, a fifth lens element, a sixth lens element, a seventh lens element and an eighth lens element in sequence, and each lens element has an object-side surface facing toward the object side and allowing imaging rays to pass through as well as an image-side surface facing toward the image side and allowing the imaging rays to pass through, wherein a lens element of the first lens group closest to the object side has positive refracting power.

4. The zoom lens according to claim 3, wherein the zoom lens satisfies the following relationships: (ER11+ER12+ER21+ER22+ER31+ER32)/EPDt≤3.700, wherein ER11 is an effective radius of the object-side surface of the first lens element, ER12 is an effective radius of the image-side surface of the first lens element, ER21 is an effective radius of the image-side surface of the first lens element, ER22 is an effective radius of the image-side surface of the second lens element, ER31 is an effective radius of the object-side surface of the third lens element, ER32 is an effective radius of the image-side surface of the third lens element, and EPDt is an entrance pupil diameter of the zoom lens in the telephoto state.

5. The zoom lens according to claim 3, wherein the zoom lens satisfies the following relationships: (ER71+ER72+ER81+ER82)/(T1+T4+T8)≤6.000, wherein ER71 is an effective radius of the object-side surface of the seventh lens element, ER72 is an effective radius of the image-side surface of the seventh lens element, and ER81 is an effective radius of the object-side surface of the eighth lens element, ER82 is an effective radius of the image-side surface of the eighth lens element, T1 is a thickness of the first lens element along the optical axis, T4 is a thickness of the fourth lens element along the optical axis, and T8 is a thickness of the eighth lens element along the optical axis.

6. The zoom lens according to claim 3, wherein the zoom lens satisfies the following relationships: DG3/(T1+T5)≤5.200, wherein DG3 is a length of the third lens group along the optical axis, T1 is a thickness of the first lens element along the optical axis, and T5 is a thickness of the fifth lens element along the optical axis.

7. The zoom lens according to claim 3, wherein the zoom lens satisfies the following relationships: DG3/(T7+T8)≤4.600, wherein DG3 is a length of the third lens group along the optical axis, T7 is a thickness of the seventh lens element along the optical axis, and T8 is a thickness of the eighth lens element along the optical axis.

8. A zoom lens comprising a first lens group, a second lens group and a third lens group in sequence along an optical axis from an object side to an image side, wherein the zoom lens can be switched between a wide-angle state and a telephoto state;
the third lens group has negative refracting power;
the zoom lens has only the above three lens groups and satisfies the following relationship:
$$TTL * ( Fnow + Fnot ) / fw \leq 20. ; ( ft + fw ) / ImgH \geq 9. ; and ft / fw \geq 1.6 ;$$
wherein TTL is a system length of the zoom lens, Fnow is an f-number of the zoom lens in the wide-angle state, Fnot is an f-number of the zoom lens in the telephoto state, fw is an effective focal length of the zoom lens in the wide-angle state, ft is an effective focal length of the zoom lens in the telephoto state, and ImgH is a maximum image height of the zoom lens.

9. The zoom lens according to claim 8, wherein the zoom lens satisfies the following relationships: DG3/(DG1+DG2)≤1.500, wherein DG1 is a length of the first lens group along the optical axis, DG2 is a length of the second lens group along the optical axis, and DG3 is a length of the third lens group along the optical axis.

10. The zoom lens according to claim 8, wherein the zoom lens comprises at least a first lens element, a second lens element, a third lens element, a fourth lens element, a fifth lens element, a sixth lens element, a seventh lens element and an eighth lens element in sequence, and each lens element has an object-side surface facing toward the object side and allowing imaging rays to pass through as well as an image-side surface facing toward the image side and allowing the imaging rays to pass through, the third lens group has a lens element closest to the image side, and the lens element closest to the image side has negative refracting power.

11. The zoom lens according to claim 10, wherein the zoom lens satisfies the following relationships: (Gall+T2+T3)/ALT≤2.800, wherein Gall is a sum of air gaps of all lens elements of the zoom lens along the optical axis plus back focal length, T2 is a thickness of the second lens element along the optical axis, T3 is a thickness of the third lens element along the optical axis, and ALT is a sum of thicknesses of all of the lens elements along the optical axis.

12. The zoom lens according to claim 10, wherein the zoom lens satisfies the following relationships: (ER61+ER62+ER71+ER72+ER81+ER82)/EPDw≤4.200, wherein ER61 is an effective radius of the object-side surface of the sixth lens element, ER62 is an effective radius of the image-side surface of the sixth lens element, ER71 is an effective radius of the object-side surface of the seventh lens element, ER72 is an effective radius of the image-side surface of the seventh lens element, ER81 is an effective radius of the object-side surface of the eighth lens element, ER82 is an effective radius of the image-side surface of the eighth lens element, and EPDw is an entrance pupil diameter of the zoom lens in the wide-angle state.

13. The zoom lens according to claim 10, wherein the zoom lens satisfies the following relationships: DG3/(T4+T6)≤4.100, wherein DG3 is a length of the third lens group along the optical axis, T4 is a thickness of the fourth lens element along the optical axis, and T6 is a thickness of the sixth lens element along the optical axis.

14. The zoom lens according to claim 10, wherein the zoom lens satisfies the following relationships: DG3/D71t82≤3.600, wherein DG3 is a length of the third lens group along the optical axis, and D71t82 is a distance from the object-side surface of the seventh lens element to the image-side surface of the eighth lens element along the optical axis.

15. A zoom lens comprising a first lens group, a second lens group and a third lens group in sequence along an optical axis from an object side to an image side, wherein the zoom lens can be switched between a wide-angle state and a telephoto state; the third lens group has a lens element closest to the image side, and a periphery region of an image-side surface of the lens element closest to the image side is convex;
the zoom lens has only the above three lens groups and satisfies the following relationships:
TTL*(Fnow+Fnot)/fw≤20.000 and
(ft+fw)/ImgH≥9.000;
wherein TTL is a system length of the zoom lens, Fnow is an f-number of the zoom lens in the wide-angle state, Fnot is an f-number of the zoom lens in the telephoto state, fw is an effective focal length of the zoom lens in the wide-angle state, ft is an effective focal length of the zoom lens in the telephoto state, and ImgH is a maximum image height of the zoom lens.

16. The zoom lens according to claim 15, wherein the zoom lens satisfies the following relationships: (ft+fw)/DG3≥3.800, wherein DG3 is a length of the third lens group along the optical axis.

17. The zoom lens according to claim 15, wherein the zoom lens comprises at least a first lens element, a second lens element, a third lens element, a fourth lens element, a fifth lens element, a sixth lens element, a seventh lens element and an eighth lens element in sequence, and each lens element has an object-side surface facing toward the object side and allowing imaging rays to pass through as well as an image-side surface facing toward the image side and allowing the imaging rays to pass through, and the zoom lens satisfies the following relationships: (ER71+ER72+ER81+ER82)/(T5+T6+T7)≤3.800, wherein ER71 is an effective radius of the object-side surface of the seventh lens element, ER72 is an effective radius of the image-side surface of the seventh lens element, ER81 is an effective radius of the object-side surface of the eighth lens element, ER82 is an effective radius of the image-side surface of the eighth lens element, T5 is a thickness of the fifth lens element along the optical axis, T6 is a thickness of the sixth lens element along the optical axis, and T7 is a thickness of the seventh lens element along the optical axis.

18. The zoom lens according to claim 17, wherein the zoom lens satisfies the following relationships: DG3/(T4+T7)≤3.000, wherein DG3 is a length of the third lens group along the optical axis, and T4 is a thickness of the fourth lens element along the optical axis.

19. The zoom lens according to claim 17, wherein the zoom lens satisfies the following relationships: DG3/(T6+T7)≤6.000, wherein DG3 is a length of the third lens group along the optical axis.

20. The zoom lens according to claim 17, wherein the zoom lens satisfies the following relationships: (T2+T3+G67)/(T5+G78)≤3.200, wherein T2 is a thickness of the second lens element along the optical axis, T3 is a thickness of the third lens element along the optical axis, G67 is an air gap between the sixth lens element and the seventh lens element along the optical axis, and G78 is an air gap between the seventh lens element and the eighth lens element along the optical axis.
